(19) United States
(12) Patent Application Publication
(10) Pub. No.: US 2015/0131445 A1
(43) Pub. Date: May 14, 2015

(54) SIMILARITY MATCHING METHOD AND RELATED DEVICE AND COMMUNICATION SYSTEM

(71) Applicant: Huawei Technologies Co., Ltd., Shenzhen (CN)

(72) Inventors: Yuxuan Nie, Shenzhen (CN); Wei Zhou, Hangzhou (CN)

(21) Appl. No.: 14/534,433

(22) Filed: Nov. 6, 2014

Related U.S. Application Data
(63) Continuation of application No. PCT/CN2014/072536, filed on Feb. 26, 2014.

(30) Foreign Application Priority Data
Jul. 19, 2013 (CN) 201310306887.2

(51) Int. Cl. H04L 12/851; H04L 12/805; H04L 12/26

(52) U.S. Cl. CPC H04L 47/2483; H04L 43/08; H04L 47/36; H04L 43/0882
USPC 370/235

(57) ABSTRACT

A similarity matching method and a related device and a communication system are provided. The method may include: obtaining unknown traffic; and separately calculating similarities between the unknown traffic and sampled traffic according to N dimensions; and performing weighted harmonic averaging for calculated similarities that are corresponding to the dimensions, to obtain a matching similarity between the unknown traffic and the sampled traffic, where, N is an integer greater than or equal to 2, and the N dimensions include N dimensions of the following dimensions: n1 dimensions related to a packet of the traffic, n2 dimensions related to a session corresponding to the traffic, and n3 dimensions related to the traffic itself, where n1, n2, and n3 are positive integers. The technical solutions of the embodiments of the present invention help to improve efficiency and accuracy of traffic analysis.

### CROSS-REFERENCE TO RELATED APPLICATION

This application is a continuation of International Application No. PCT/CN2014/072536, filed on Feb. 26, 2014, which claims priority to Chinese Patent Application No. 201310306887.2, filed on Jul. 19, 2013, both of which are hereby incorporated by reference in their entireties.

### TECHNICAL FIELD

The present invention relates to the field of communications technologies, and in particular, to a similarity matching method and a related device and a communication system.

### BACKGROUND

Currently, broadband services bring not only opportunities but also challenges to operators. The operators need to face a series of new topics such as bandwidth management, content charging, and information security. In face of growing service traffic, a deep packet inspection (DPI, Deep Packet Inspection) technology is considered as an effective method for meeting management and control challenges brought by multiple services of a network. Coverage of regional traffic is an important metric for measuring a DPI capability.

However, with the popularity of intelligent terminals such as smart phones, the quantity of applications grows explosively. In addition, more and more applications (applications such as Skype and Vbuzzer) always evade inspection of DPI manufacturers by automatically changing traffic features of the applications, including variations of behavior features, binary changes, mixture of traffic, addition of random lengths, and other manners of changing traffic features. Facing challenges of unknown traffic brought by new applications, the industry commonly makes analysis by capturing traffic of a live network+manual analysis at present.

In the process of researching and practicing the prior art, the inventors of the present invention find that the prior art generally has the following disadvantages: The existing manual analysis manner has low efficiency and a low response speed, and can hardly satisfy requirements of operators on coverage of the live network in time and hardly support analysis and identification of traffic of new applications; and accuracy can hardly satisfy requirements of refined services.

### SUMMARY

Embodiments of the present invention provide a similarity matching method and a related device and a communication system to improve efficiency and accuracy of traffic analysis.

According to a first aspect, the present invention provides a similarity matching method, which may include:

obtaining unknown traffic; and

separately calculating similarities between the unknown traffic and sampled traffic according to N dimensions; and performing weighted harmonic averaging for calculated similarities that are corresponding to the dimensions, to obtain a matching similarity between the unknown traffic and the sampled traffic, where, N is an integer greater than or equal to 2, and the N dimensions include two or more of the following dimensions: n1 dimensions related to a packet of the traffic, n2 dimensions related to a session corresponding to the traffic, and n3 dimensions related to the traffic itself, where n1, n2, and n3 are positive integers.

With reference to the first aspect, in a first possible implementation manner, the separately calculating similarities between the unknown traffic and sampled traffic according to N dimensions includes: when the unknown traffic fails to be identified based on a deep packet inspection technology, separately calculating the similarities between the unknown traffic and the sampled traffic according to the N dimensions.

With reference to the first aspect or the first possible implementation manner of the first aspect, in a second possible implementation manner, the separately calculating similarities between the unknown traffic and sampled traffic according to N dimensions includes: performing at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic; and

calculating a similarity between a traffic volume of first M packets of the unknown traffic and a traffic volume of first M packets of the sampled traffic.

With reference to the second possible implementation manner of the first aspect, in a third possible implementation manner, the calculating a similarity between packet payload content of the unknown traffic and packet payload content of the sampled traffic includes:

calculating a similarity between characters of the packet payload content of the unknown traffic and characters of the packet payload content of the sampled traffic;

calculating a matching degree between the packet payload content of the unknown traffic and the packet payload content of the sampled traffic; and

calculating a product of a square root of the matching degree and the character similarity, where the product obtained by calculation is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic.

With reference to the second possible implementation manner of the first aspect or the third possible implementation manner of the first aspect, in a fourth possible implementation manner, the calculating a similarity between a packet length of the unknown traffic and a packet length of the sampled traffic includes: dividing the packet length of the unknown traffic by the packet length of the sampled traffic to obtain a quotient, where the quotient is the similarity between the packet length of the unknown traffic and the packet length of the sampled traffic; or, determining a first length interval within which the packet length of the unknown traffic falls, and determining, according to a correspondence relationship between a length interval and a similarity value, a similarity value corresponding to the first length interval, where the similarity value corresponding to the first length interval is the similarity between the packet length of the unknown traffic and the packet length of the sampled traffic.

According to a second aspect, the present invention provides a similarity matching apparatus, including:

an obtaining unit, configured to obtain unknown traffic; and

a similarity calculating unit, configured to separately calculate, according to N dimensions, similarities between sampled traffic and the unknown traffic obtained by the obtaining unit; and perform weighted harmonic averaging for calculated similarities that are corresponding to the dimensions, to obtain a matching similarity between the unknown traffic and the sampled traffic, where, N is an integer greater than or equal to 2, and the N dimensions include two or more of the following dimensions: n1 dimensions related to a packet of the traffic, n2 dimensions related to a session corresponding to the traffic, and n3 dimensions related to the traffic itself, where n1, n2, and n3 are positive integers.

With reference to the second aspect, in a first possible implementation manner,

the similarity calculating unit is specifically configured to separately calculate the similarities between the unknown traffic and the sampled traffic according to the N dimensions when the unknown traffic fails to be identified based on a deep packet inspection technology; and perform weighted harmonic averaging for the calculated similarities that are corresponding to the dimensions, to obtain the matching similarity between the unknown traffic and the sampled traffic, where, N is an integer greater than or equal to 2, and the N dimensions include two or more of the following dimensions: n1 dimensions related to a packet of the traffic, n2 dimensions related to a session corresponding to the traffic, and n3 dimensions related to the traffic itself, where n1, n2, and n3 are positive integers.

With reference to the second aspect or the first possible implementation manner of the second aspect, in a second possible implementation manner, in respect of the separately calculating similarities between the unknown traffic and sampled traffic according to N dimensions, the similarity calculating unit is specifically configured to perform at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic;

calculating a similarity between a traffic volume of first M packets of the unknown traffic and a traffic volume of first M packets of the sampled traffic; and

performing weighted harmonic averaging for at least two similarities obtained by calculation, to obtain the matching similarity between the unknown traffic and the sampled traffic.

With reference to the second possible implementation manner of the second aspect, in a third possible implementation manner, in respect of the calculating a similarity between packet payload content of the unknown traffic and packet payload content of the sampled traffic, the similarity calculating unit is specifically configured to:

calculate a similarity between characters of the packet payload content of the unknown traffic and characters of the packet payload content of the sampled traffic;

calculate a matching degree between the packet payload content of the unknown traffic and the packet payload content of the sampled traffic; and

calculate a product of a square root of the matching degree and the character similarity, where the product obtained by calculation is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic.

With reference to the second possible implementation manner of the second aspect, in a fourth possible implementation manner, in respect of the calculating a similarity between a packet length of the unknown traffic and a packet length of the sampled traffic, the similarity calculating unit is specifically configured to divide the packet length of the unknown traffic by the packet length of the sampled traffic to obtain a quotient, where the quotient is the similarity between the packet length of the unknown traffic and the packet length of the sampled traffic; or, determine a first length interval within which the packet length of the unknown traffic falls, and determine, according to a correspondence relationship between a length interval and a similarity value, a similarity value corresponding to the first length interval, where the similarity value corresponding to the first length interval is the similarity between the packet length of the unknown traffic and the packet length of the sampled traffic.

According to a third aspect, the present invention provides a traffic analysis server, which may include:

a deep packet inspection identification system, configured to obtain unknown traffic, and identify the unknown traffic based on a deep packet inspection technology; and

a similarity matching system, configured to separately calculate similarities between the unknown traffic and sampled traffic according to N dimensions when the deep packet inspection identification system fails to identify the unknown traffic based on the deep packet inspection technology; and perform weighted harmonic averaging for calculated similarities that are corresponding to the dimensions, to obtain a matching similarity between the unknown traffic and the sampled traffic, where, N is an integer greater than or equal to 2, and the N dimensions include two or more of the following dimensions: n1 dimensions related to a packet of the traffic, n2 dimensions related to a session corresponding to the traffic, and n3 dimensions related to the traffic itself, where n1, n2, and n3 are positive integers.

With reference to the third aspect, in a first possible implementation manner, in respect of the separately calculating similarities between the unknown traffic and sampled traffic according to N dimensions, the similarity matching system is specifically configured to perform at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic; and

calculating a similarity between a traffic volume of first M packets of the unknown traffic and a traffic volume of first M packets of the sampled traffic.

With reference to the second possible implementation manner of the third aspect, in a third possible implementation manner,

in respect of the calculating a similarity between packet payload content of the unknown traffic and packet payload content of the sampled traffic, the similarity matching system is specifically configured to: calculate a similarity between characters of the packet payload content of the unknown traffic and characters of the packet payload content of the sampled traffic; calculate a matching degree between the packet payload content of the unknown traffic and the packet payload content of the sampled traffic; and calculate a product of a square root of the matching degree and the character similarity, where the product obtained by calculation is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic;

and/or, in respect of the calculating a similarity between a packet length of the unknown traffic and a packet length of the sampled traffic, the similarity matching system is specifically configured to: divide the packet length of the unknown traffic by the packet length of the sampled traffic to obtain a quotient, where the quotient is the similarity between the packet length of the unknown traffic and the packet length of the sampled traffic; or, determine a first length interval within which the packet length of the unknown traffic falls, and determine, according to a correspondence relationship between a length interval and a similarity value, a similarity value corresponding to the first length interval, where the similarity value corresponding to the first length interval is the similarity between the packet length of the unknown traffic and the packet length of the sampled traffic.

According to a fourth aspect, the present invention provides a communication system, which may include:

a communication network element and a traffic analysis server;

where the communication network element is configured to receive unknown traffic; and

the traffic analysis server is configured to obtain the unknown traffic received by the communication network element or obtain a mirror of the unknown traffic received by the communication network element, and identify the unknown traffic or the mirror of the unknown traffic based on a deep packet inspection technology; when the unknown traffic or the mirror of the unknown traffic fails to be identified based on the deep packet inspection technology, separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, the N dimensions include two or more of the following dimensions: n1 dimensions related to a packet of the traffic, n2 dimensions related to a session corresponding to the traffic, and n3 dimensions related to the traffic itself, where n1, n2, and n3 are positive integers.

With reference to the fourth aspect, in a first possible implementation manner, in respect of the separately calculating similarities between the unknown traffic or the mirror of the unknown traffic and sampled traffic according to N dimensions, the traffic analysis server is specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

With reference to the first possible implementation manner of the fourth aspect, in a second possible implementation manner,

in respect of the calculating a similarity between packet payload content of the unknown traffic or the mirror of the unknown traffic and packet payload content of the sampled traffic, the traffic analysis server is specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic;

and/or,

in respect of the calculating a similarity between a packet length of the unknown traffic or the mirror of the unknown traffic and a packet length of the sampled traffic, the traffic analysis server is specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

According to a fifth aspect, the present invention provides a communication system, including:

a communication network element and a similarity matching server;

where the communication network element is configured to receive unknown traffic, identify the unknown traffic based on a deep packet inspection technology, and if the unknown traffic fails to be identified, send the unidentified unknown traffic or a mirror of the unidentified unknown traffic to the similarity matching server; and

the similarity matching server is configured to receive the unidentified unknown traffic or the mirror of the unknown traffic from the communication network element, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, N is an integer greater than or equal to 2, and the N dimensions include two or more of the following dimensions: n1 dimensions related to a packet of the traffic, n2 dimensions related to a session corresponding to the traffic, and n3 dimensions related to the traffic itself, where n1, n2, and n3 are positive integers.

With reference to the fifth aspect, in a first possible implementation manner, in respect of the separately calculating similarities between the unknown traffic or the mirror of the unknown traffic and sampled traffic according to N dimensions, the similarity matching server is specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

With reference to the first possible implementation manner of the fifth aspect, in a second possible implementation manner, in respect of the calculating a similarity between packet payload content of the unknown traffic or the mirror of the unknown traffic and packet payload content of the sampled traffic, the similarity matching server is specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic;

and/or,

in respect of the calculating a similarity between a packet length of the unknown traffic or the mirror of the unknown traffic and a packet length of the sampled traffic, the similarity matching server is specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

According to a sixth aspect, the present invention provides a communication system, which may include:

a communication network element and a deep packet inspection identification server;

where the communication network element is configured to receive unknown traffic;

the deep packet inspection identification server is configured to obtain the unknown traffic received by the communication network element or obtain a mirror of the unknown traffic received by the communication network element; and identify the unknown traffic or the mirror of the unknown traffic based on a deep packet inspection technology, and if the unknown traffic or the mirror of the unknown traffic fails to be identified, send the unidentified unknown traffic or the mirror of the unidentified unknown traffic to the communication network element; and

the communication network element is further configured to receive the unidentified unknown traffic or the mirror of the unidentified unknown traffic from the deep packet inspection identification server, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, N is an integer greater than or equal to 2, and the N dimensions include two or more of the following dimensions: n1 dimensions related to a packet of the traffic, n2 dimensions related to a session corresponding to the traffic, and n3 dimensions related to the traffic itself, where n1, n2, and n3 are positive integers.

With reference to the sixth aspect, in a first possible implementation manner, in respect of the separately calculating similarities between the unknown traffic or the mirror of the unknown traffic and sampled traffic according to N dimensions, the communication network element is specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

With reference to the first possible implementation manner of the sixth aspect, in a second possible implementation manner, in respect of the calculating a similarity between packet payload content of the unknown traffic or the mirror of the unknown traffic and packet payload content of the sampled traffic, the communication network element is specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic;

and/or,

in respect of the calculating a similarity between a packet length of the unknown traffic or the mirror of the unknown traffic and a packet length of the sampled traffic, the communication network element is specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

According to a seventh aspect, the present invention provides a communication system, which may include:

a communication network element, a deep packet inspection identification server, and a similarity matching server;

where the communication network element is configured to receive unknown traffic;

the deep packet inspection identification server is configured to obtain the unknown traffic received by the communication network element or obtain a mirror of the unknown traffic received by the communication network element; and identify, based on a deep packet inspection technology, the unknown traffic or the mirror of the unknown traffic received by the communication network element, and if the unknown traffic or the mirror of the unknown traffic fails to be identified, send the unidentified unknown traffic or the mirror of the unidentified unknown traffic to the similarity matching server; and

the similarity matching server is configured to receive the unidentified unknown traffic or the mirror of the unidentified unknown traffic from the deep packet inspection identification server, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, the N dimensions include two or more of the following dimensions: n1 dimensions related to a packet of the traffic, n2 dimensions related to a session corresponding to the traffic, and n3 dimensions related to the traffic itself, where N is an integer greater than or equal to 2, and n1, n2, and n3 are positive integers.

With reference to the seventh aspect, in a first possible implementation manner, in respect of the separately calculating similarities between the unknown traffic or the mirror of the unknown traffic and sampled traffic according to N dimensions, the similarity matching server is specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

With reference to the first possible implementation manner of the seventh aspect, in a second possible implementation manner, in respect of the calculating a similarity between packet payload content of the unknown traffic or the mirror of the unknown traffic and packet payload content of the sampled traffic, the similarity matching server is specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic;

and/or,

in respect of the calculating a similarity between a packet length of the unknown traffic or the mirror of the unknown traffic and a packet length of the sampled traffic, the similarity matching server is specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

According to an eighth aspect, the present invention provides a traffic analysis server, where the traffic analysis server includes:

a receiver configured to receive unknown traffic or a mirror of unknown traffic, a similarity identification engine coupled with the receiver, and a transmitter configured to send a matching similarity between the unknown traffic and sampled traffic, or send a matching similarity between the mirror of the unknown traffic and sampled traffic, or send a matching similarity between the unknown traffic output by the similarity identification engine and sampled traffic, or send a matching similarity between the mirror of the unknown traffic output by the similarity identification engine and sampled traffic, where the similarity identification engine is the similarity matching apparatus according to the foregoing embodiment.

According to a ninth aspect, the present invention provides a communication network element, including a transceiver and a processor coupled with the transceiver and configured to perform network communication, where the communication device further includes: a similarity identification engine coupled with the transceiver, where the similarity identification engine is the similarity matching apparatus according to the foregoing embodiment.

As can be seen from the above, in a solution of an embodiment of the present invention, after unknown traffic is obtained, similarities between the unknown traffic and sampled traffic are separately calculated according to N dimensions; and weighted harmonic averaging is performed for calculated similarities that are corresponding to the dimensions, to obtain a matching similarity between the unknown traffic and the sampled traffic, where, N is an integer greater than or equal to 2. An embodiment of the present invention provides a mechanism that may use a traffic analysis device to analyze similar traffic, which helps to improve efficiency of traffic analysis. Because similarities between unknown traffic and sampled traffic are separately calculated according to N dimensions, and the similarities obtained according to the N dimensions are integrated, where the N dimensions include two or more dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic flowchart of a similarity matching method according to an embodiment of the present invention;

FIG. 2-a is a schematic architectural diagram of a network in which a traffic analysis device is located according to an embodiment of the present invention;

FIG. 2-b is a schematic diagram of deployment of a similarity matching system and a DPI identification system according to an embodiment of the present invention;

FIG. 2-c is a schematic diagram of deployment of another similarity matching system and another DPI identification system according to an embodiment of the present invention;

FIG. 2-d is a schematic diagram of deployment of another similarity matching system and another DPI identification system according to an embodiment of the present invention;

FIG. 3 is a schematic flowchart of a traffic analysis method according to an embodiment of the present invention;

FIG. 4-a is a schematic diagram of distribution of port numbers of a type of sampled traffic according to an embodiment of the present invention;

FIG. 4-b is a schematic diagram of distribution of packet lengths of a type of sampled traffic according to an embodiment of the present invention;

FIG. 4-c is a schematic diagram of distribution of packet lengths of another type of sampled traffic according to an embodiment of the present invention;

FIG. 4-d is a schematic diagram of distribution of packet transmission rates of a type of sampled traffic according to an embodiment of the present invention;

FIG. 4-e is a schematic diagram of distribution of packet transmission rates of another type of sampled traffic according to an embodiment of the present invention;

FIG. 5 is a schematic diagram of a similarity matching server according to an embodiment of the present invention;

FIG. 6 is a schematic diagram of another similarity matching server according to an embodiment of the present invention;

FIG. 7 is a schematic diagram of a communication system according to an embodiment of the present invention;

FIG. 8 is a schematic diagram of a traffic analysis server according to an embodiment of the present invention;

FIG. 9 is a schematic diagram of another communication system according to an embodiment of the present invention;

FIG. 10 is a schematic diagram of another communication system according to an embodiment of the present invention;

FIG. 11 is a schematic diagram of another communication system according to an embodiment of the present invention;

FIG. 12 is a schematic diagram of another communication system according to an embodiment of the present invention;

FIG. 13 is a schematic diagram of another similarity matching server according to an embodiment of the present invention;

FIG. 14-a is a schematic diagram of a communication network element according to an embodiment of the present invention;

FIG. 14-b is a schematic diagram of another communication network element according to an embodiment of the present invention;

FIG. 15-a is a schematic diagram of a traffic analysis server according to an embodiment of the present invention; and

FIG. 15-b is a schematic diagram of another traffic analysis server according to an embodiment of the present invention.

### DETAILED DESCRIPTION

Embodiments of the present invention provide a similarity matching method and a related device and a communication system to improve efficiency and accuracy of traffic analysis.

To make persons skilled in the art understand the technical solutions in the present invention better, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention. The embodiments of the present invention are hereinafter described in detail:

The terms “first”, “second”, “third”, “fourth”, and so on (if existent) in the specification and claims and the drawings of the present invention are used to distinguish similar objects instead of describing a specific sequence or order. It should be understood that the data used in this way may be interchanged under appropriate circumstances, so that the embodiments of the present invention described herein can be implemented in another sequence in addition to the sequences illustrated or described herein. In addition, the terms “include”, “have”, and any other variant thereof are intended to cover a non-exclusive inclusion, for example, a process, method, system, product, or device that includes a series of steps or units is not limited to the expressly listed steps or units, but may include other steps or units which are not expressly listed or are inherent to the process, method, product, or device.

In an embodiment of the similarity matching method according to the present invention, a similarity matching method may include: obtaining unknown traffic; and separately calculating similarities between the unknown traffic and sampled traffic according to N dimensions; and performing weighted harmonic averaging for calculated similarities that are corresponding to the dimensions, to obtain a matching similarity between the unknown traffic and the sampled traffic, where, N is an integer greater than or equal to 2.

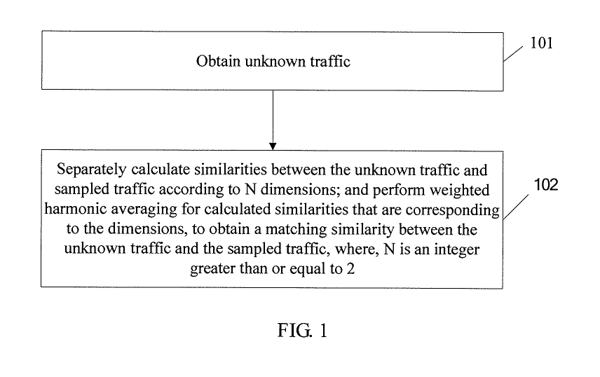

Referring to FIG. 1, FIG. 1 is a schematic flowchart of a similarity matching method according to an embodiment of the present invention. As shown in FIG. 1, a similarity matching method according to an embodiment of the present invention may include the following processes:

101. Obtain unknown traffic.

A device or system used for implementing similarity matching may obtain unknown traffic from a DPI server or a network element (where the network element may be, for example, a base station, a base station controller, a gateway, or a server).

102. Separately calculate similarities between the unknown traffic and sampled traffic according to N dimensions; and perform weighted harmonic averaging for calculated similarities that are corresponding to the dimensions, to obtain a matching similarity between the unknown traffic and the sampled traffic, where, N is an integer greater than or equal to 2.

The N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

It may be understood that the matching similarity between the unknown traffic and the sampled traffic is equal to a value obtained by calculation by performing weighted harmonic averaging for the obtained similarity corresponding to each dimension, that is, the matching similarity is a result of integrating similarities corresponding to the N dimensions. The matching similarity helps to reflect similarities between the unknown traffic and the sampled traffic more objectively and accurately.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

In some embodiments of the present invention, before the similarities between the unknown traffic and the sampled traffic are separately calculated according to the N dimensions, the obtained unknown traffic may be first identified based on a DPI technology. If the unknown traffic is successfully identified based on the DPI technology, an identification result of the DPI technology may be output. The step of separately calculating similarities between the unknown traffic and sampled traffic according to N dimensions is performed only after the unknown traffic fails to be identified based on the DPI technology.

In some embodiments of the present invention, if the obtained matching similarity between the sampled traffic and the unknown traffic is greater than a set similarity threshold, a traffic analysis device may output a traffic identification result indicating successful matching between the unknown traffic and the sampled traffic (where the traffic identification result may indicate, for example, that the unknown traffic and the sampled traffic are of a same service type. In this case, charging for the unknown traffic may be performed according to a package charging mode corresponding to the service type of the sampled traffic. For example, an Fk1 package service exists, all traffic for a user to access the Fk1 is free, and separate charging is performed for external video traffic and advertisement traffic of the Fk1. Other service scenarios are deduced in the same way). In addition, if the obtained matching similarity between the sampled traffic and the unknown traffic is less than the set similarity threshold, the traffic analysis device may output a traffic identification result indicating failed matching between the unknown traffic and the sampled traffic.

A dimension used for identification may be selected according to actual requirements. Selected dimensions may vary according to different application scenarios and different accuracy requirements. For example, at least two dimensions may be selected from the following dimensions to calculate the similarities between the unknown traffic and the sampled traffic: packet payload content, a packet length, a packet port number, a packet transmission rate, an uplink packet quantity, a downlink packet quantity, a ratio of the uplink packet quantity to the downlink packet quantity, an uplink traffic volume, a downlink traffic volume, a ratio of the uplink traffic volume to the downlink traffic volume, a traffic volume of first M packets, and so on. Certainly, the embodiment of the present invention is not limited to the foregoing dimensions, and other dimensions may also be introduced.

In some embodiments of the present invention, the separately calculating similarities between the unknown traffic and sampled traffic according to N dimensions includes: performing at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic; and

calculating a similarity between a traffic volume of first M packets of the unknown traffic and a traffic volume of first M packets of the sampled traffic.

In an actual application, multiple manners compliant with the computation logic in the field may be used to calculate a similarity between the unknown traffic and the sampled traffic according to a corresponding dimension. For example, the calculating a similarity between packet payload content of the unknown traffic and packet payload content of the sampled traffic may include: calculating a similarity between characters of the packet payload content of the unknown traffic and characters of the packet payload content of the sampled traffic; calculating a matching degree between the packet payload content of the unknown traffic and the packet payload content of the sampled traffic; and calculating a product of a square root of the matching degree and the character similarity, where the product obtained by calculation is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic.

In some embodiments of the present invention, the calculating a similarity between a packet length of the unknown traffic and a packet length of the sampled traffic may include, for example, dividing the packet length of the unknown traffic by the packet length of the sampled traffic to obtain a quotient, where the quotient is the similarity between the packet length of the unknown traffic and the packet length of the sampled traffic; or, determining a first length interval within which the packet length of the unknown traffic falls, and determining, according to a correspondence relationship between a length interval and a similarity value, a similarity value corresponding to the first length interval, where the similarity value corresponding to the first length interval is the similarity between the packet length of the unknown traffic and the packet length of the sampled traffic.

Manners of calculating similarities corresponding to other dimensions may be deduced in the same way, and are not further enumerated one by one herein.

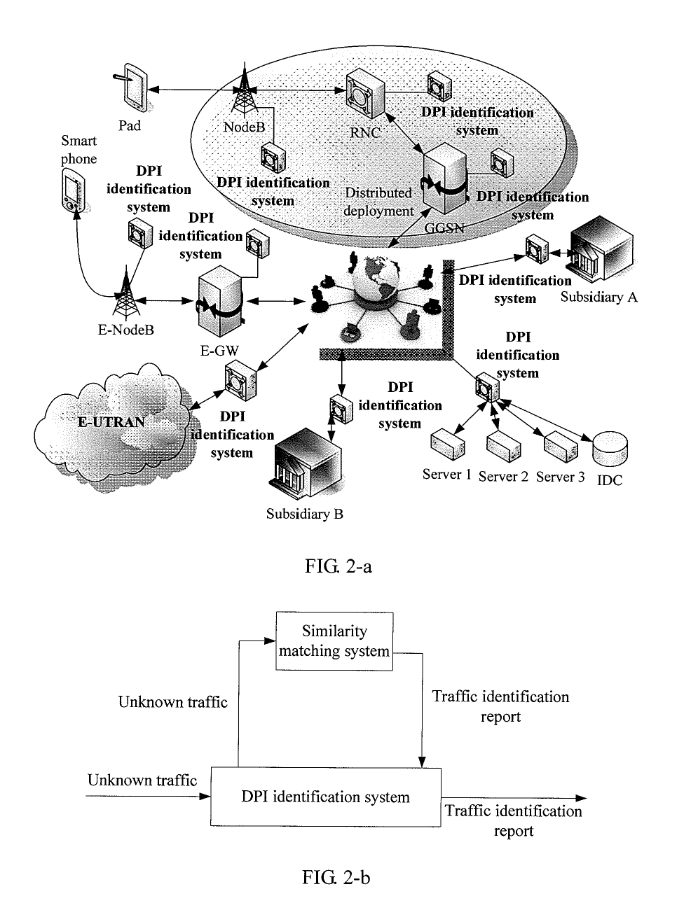

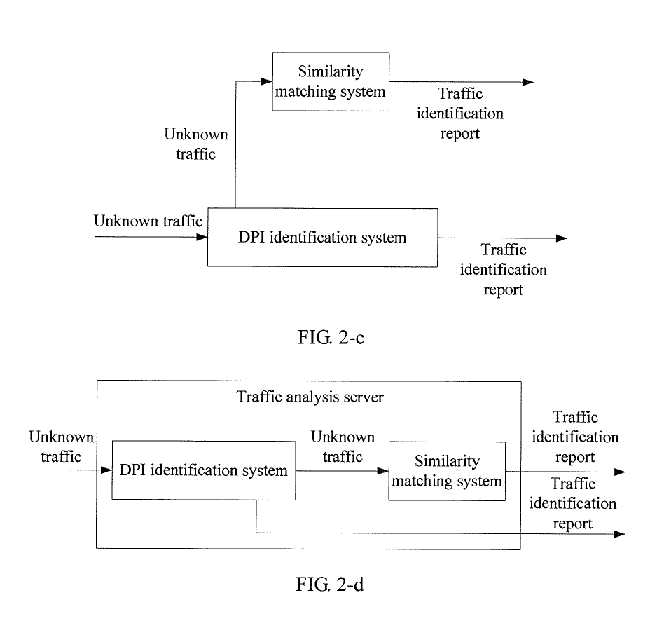

As shown in FIG. 2-a, by deployment, a DPI identification system may obtain traffic of multiple devices in a network. For example, the DPI identification system may be a card or a software module, and the DPI identification system may be embedded into a network element such as a base station controller or a data gateway. Alternatively, the DPI identification system may be used as an independent device, and may be connected externally or in series or in other manners to access a network. For example, as shown in FIG. 2-a, the DPI identification system may be deployed, in a manner of being connected externally or in series or in other manners, in multiple positions of a network system (positions such as the base station, the base station controller, the gateway, and the server) to analyze device traffic to be analyzed.

Referring to FIG. 2-b, FIG. 2-c, and FIG. 2-d, FIG. 2-b, FIG. 2-c, and FIG. 2-d illustrate a deployment position relationship between a DPI identification system and a similarity matching system. Referring to FIG. 2-b and FIG. 2-c, the similarity matching system and DPI system may be used as a whole. Certainly, the similarity matching system and the DPI identification system may also be two independent devices, where the similarity matching system and the DPI identification system may be collectively called a traffic analysis system. FIG. 2-b shows a scenario in which a similarity matching system may connect to (bypass) a DPI identification system. The similarity matching system may feed back a traffic identification report to the DPI identification system. The DPI identification system reports the traffic identification report to related devices (for example, a charging server and so on) uniformly. Certainly, the similarity matching system and the DPI identification system may also separately report their traffic identification reports to the related devices (for example, a charging server and so on) (as shown in FIG. 2-c). FIG. 2-d shows a scenario in which a similarity matching system may be integrated with a DPI identification system. FIG. 2-d illustrates that a similarity matching system and a DPI identification system may be integrated in a traffic analysis server. It may be understood that at least one of the similarity matching system and the DPI identification system may be integrated in a communication network element. Certainly, the similarity matching system and the DPI identification system may also be devices independent of the communication network element. The traffic identification report may carry a matching similarity between unknown traffic and sampled traffic, or may carry information indicating whether unknown traffic matches sampled traffic (for example, when the matching similarity is greater than a set threshold, it indicates that the unknown traffic matches the sampled traffic, or when the matching similarity is less than a set threshold, it indicates that the unknown traffic does not match the sampled traffic). A related device receiving the traffic identification report (for example, a charging server or the like) may perform corresponding processing based on the traffic identification report (for example, traffic charging processing or the like).

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, in a solution of an embodiment of the present invention, after unknown traffic is obtained, similarities between the unknown traffic and sampled traffic are separately calculated according to N dimensions; and weighted harmonic averaging is performed for calculated similarities that are corresponding to the dimensions, to obtain a matching similarity between the unknown traffic and the sampled traffic, where, N is an integer greater than or equal to 2. A mechanism that may use a traffic analysis device to analyze similar traffic is provided, which helps to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

For better understanding and implementing the foregoing solution of the embodiment of the present invention, the following uses some application scenarios as examples for description.

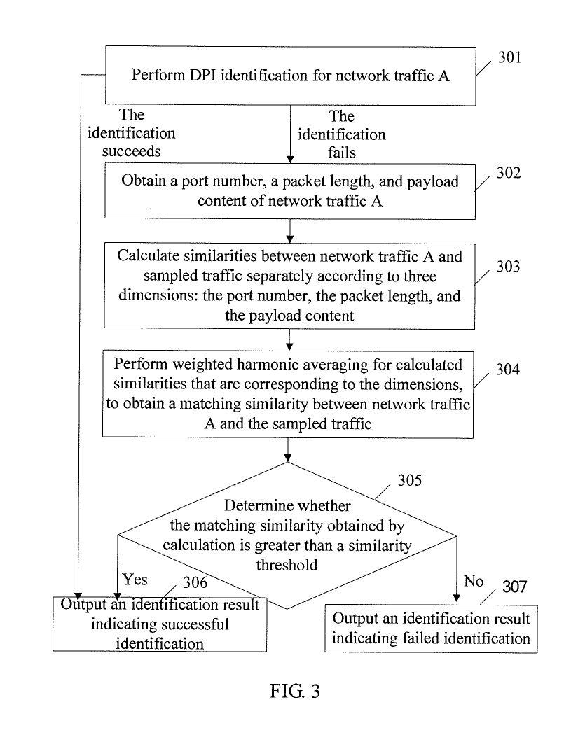

Referring to FIG. 3, FIG. 3 is a schematic flowchart of a traffic analysis method according to another embodiment of the present invention. As shown in FIG. 3, the traffic analysis method according to another embodiment of the present invention may include the following processes:

301. Perform DPI identification for network traffic A (namely, unknown traffic).

In the DPI identification, an identification technology based on a feature field is the most basic, and is applied most extensively. Different applications usually use different protocols. However, various protocols have their special fingerprints. These fingerprints may be a specific port, a specific string, or a specific bit (Bit) sequence. The identification technology based on the feature field just determines, by identifying fingerprint information in data packets of network traffic A, an application carried by service traffic. According to different specific inspection manners, the identification technology based on the feature field may be further classified into three branch technologies: fixed position feature field matching, variable position feature field matching, and state feature field matching. Related mechanisms of the DPI identification are not further described herein.

If the DPI identification succeeds, step 306 is performed.

If the DPI identification fails, step 302 is performed.

It is assumed that the features of network traffic A are as follows:

a source port is 1433,

a destination port is 2457,

a source IP address is 192.168.1.2,

a destination IP address is 192.168.1.1,

payload content is abefgabc785551 . . . ,

a payload length is 97 bytes,

a packet transmission rate is sending a packet every 13 ms, and

a protocol of network traffic A is a Transmission Control Protocol.

302. Obtain the port number, packet length, and payload content of network traffic A.

303. Calculate similarities between network traffic A and sampled traffic separately according to three dimensions: the port number, the packet length, and the payload content.

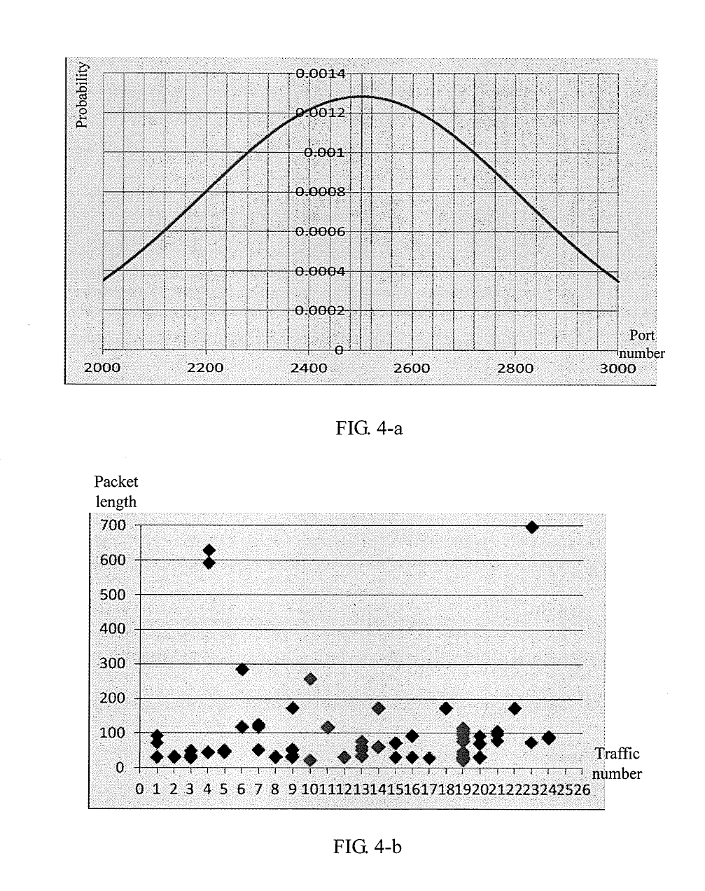

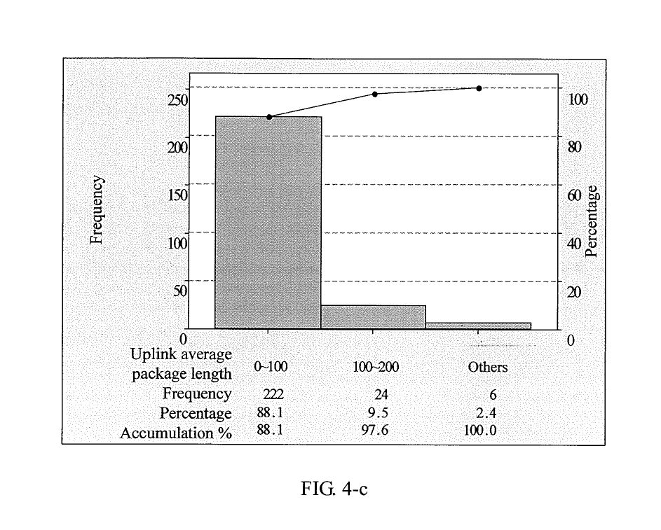

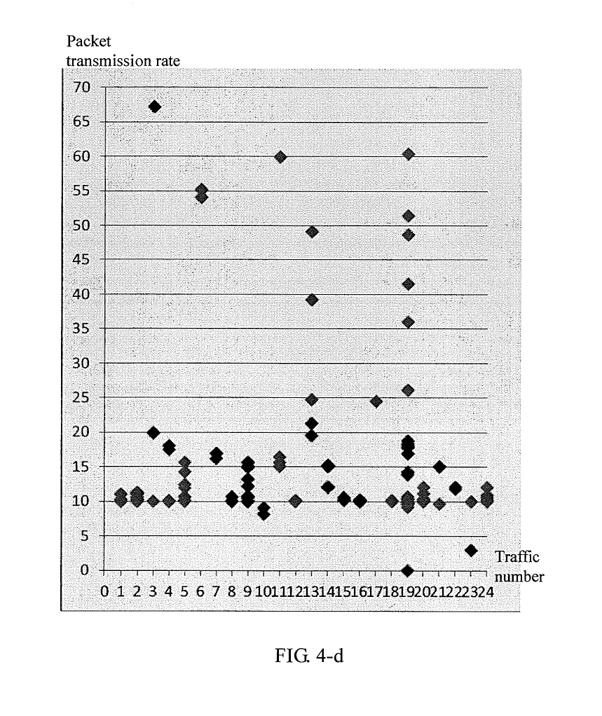

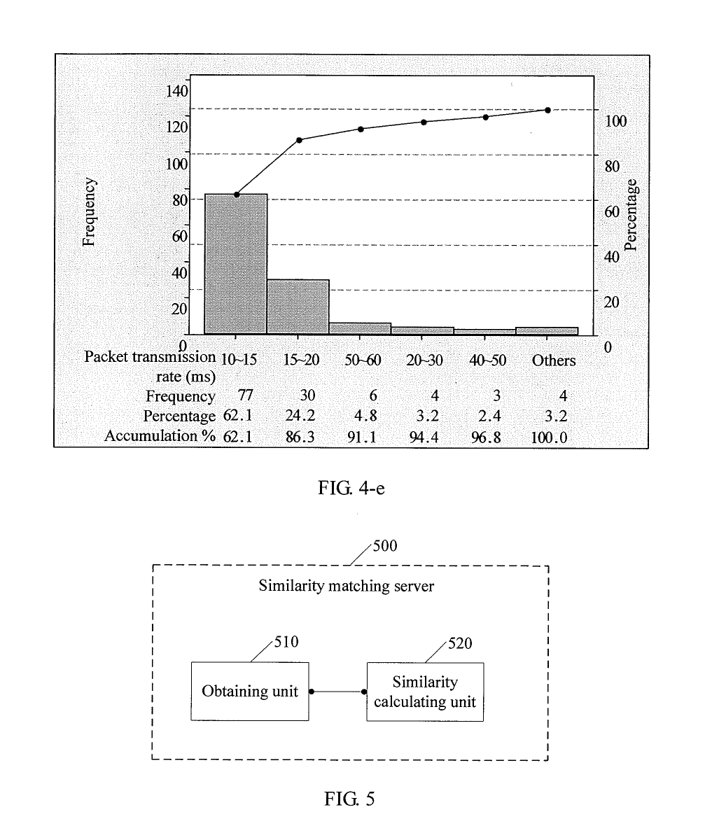

It is assumed that: payload content of the sampled traffic is aabcabce, an offset is 0, the sampled traffic is carried by the Transmission Control protocol, and a protocol name is VoIPA. It is assumed that a distribution of port numbers of the sampled traffic is shown in FIG. 4-a. In FIG. 4-a, a horizontal coordinate indicates port numbers, and a vertical coordinate indicates probabilities. Distributions of packet lengths of the sampled traffic are shown in FIG. 4-b and FIG. 4-c. In FIG. 4-b, a horizontal coordinate indicates traffic numbers, and a vertical coordinate indicates packet lengths. In FIG. 4-c, a horizontal coordinate indicates segments of uplink packet lengths (divided into three segments in the figure), the left of the vertical coordinate indicates occurrence frequencies of the segments, and the right of the vertical coordinate indicates percentages of the segments. Distributions of packet transmission rates of the sampled traffic are shown in FIG. 4-d and FIG. 4-e. In FIG. 4-d, a horizontal coordinate indicates traffic numbers, and a vertical coordinate indicates packet transmission rates. In FIG. 4-e, a horizontal coordinate indicates segments of packet transmission rates (divided into five segments in the figure), the left of the vertical coordinate indicates occurrence frequencies of the segments, and the right of the vertical coordinate indicates percentages of the segments.

In some embodiments of the present invention, a similarity between payload content of network traffic A and payload content of the sampled traffic may be calculated based on the law of cosine. Assuming that payload content of network traffic A is a string s1, and that the payload content of the sampled traffic is a string s2, the similarity sim(s1, s2) between the two strings is determined by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of network traffic A and the payload content of the sampled traffic. Conversely, a less cosine value indicates a larger angle between the vectors v1 and v2 corresponding to the two strings and a less similarity between the string s1 and string s2, that is, a less similarity between the payload content of network traffic A and the payload content of the sampled traffic.

In some embodiments of the present invention, the similarity between the payload content of network traffic A and the payload content of the sampled traffic may also be calculated based on a longest common substring. Assuming that payload content of network traffic A is a string s1, and that the payload content of the sampled traffic is a string s2, a matrix may be used to record a matching result between two characters corresponding to the two strings in all positions thereof. If the two characters are matched, 1 is recorded, or otherwise, 0 is recorded. Then, one sequence with a longest diagonal in the matrix is solved, where a position corresponding to the sequence is a position of a longest matching substring. For example, a longer longest common substring indicates a greater similarity between two strings, that is, a greater similarity between the payload content of network traffic A and the payload content of the sampled traffic. Conversely, a shorter longest common substring indicates a less similarity between two strings, that is, a less similarity between the payload content of network traffic A and the payload content of the sampled traffic.

In some embodiments of the present invention, the similarity between the payload content of network traffic A and the payload content of the sampled traffic may also be calculated based on the following manner: calculating a similarity between characters of the packet payload content of network traffic A and characters of the packet payload content of the sampled traffic; calculating a matching degree between the packet payload content of network traffic A and the packet payload content of the sampled traffic; and calculating a product of a square root of the matching degree and the character similarity, and using the product obtained by calculation as the similarity between the packet payload content of network traffic A and the packet payload content of the sampled traffic, where the character similarity is equal to a quantity of same characters between the packet payload content of network traffic A and the packet payload content of the sampled traffic, divided by a total quantity of characters of the packet payload content of the sampled traffic, and the matching degree is equal to 1 minus a differentiation degree between the packet payload content of network traffic A and the packet payload content of the sampled traffic, where the differentiation degree is equal to a quantity of characters, in the packet payload content of the sampled traffic, which are different from network traffic A, divided by a total quantity of characters of the packet payload content of the sampled traffic.

Certainly, the manner of calculating the similarity between the payload content of network traffic A and the payload content of the sampled traffic is not limited to the foregoing manner.

In some embodiments of the present invention, a similarity between the packet length of network traffic A and a packet length of the sampled traffic may be calculated based on the following piecewise function:

$$P = \{ \begin{matrix}0.881 & x ∈ [ 0 , 100 ] \\ 0.095 & x ∈ ( 100 , 200 ] \\ 0.024 & x ∈ ( 200 , + ∞ )\end{matrix}$$

Based on the piecewise function, the similarity 0.881 between the packet length of network traffic A and the packet length of the sampled traffic may be obtained, because the packet length x of network traffic A falls within a first length interval[0, 100], and the similarity corresponding to the first length interval[0, 100] is equal to 0.881. For a segment used in the piecewise function, reference may be made to a classification method used in Wireshark software. Certainly, the manner of calculating the similarity between the packet length of network traffic A and the packet length of the sampled traffic is limited to the foregoing manner.

In some embodiments of the present invention, a similarity between a port of network traffic A and a port of the sampled traffic may be calculated based on a normal distribution mechanism.

A normal distribution formula is as follows:

$$f ( x ) = \frac{1}{\sqrt{2 π} σ} {e}^{\frac{{( x - μ )}^{2}}{2 {σ}^{2}}}$$

The normal distribution formula has distribution of continuous random variables of two parameters μ and σ2. The first parameter μ is an average value of random variables complying with normal distribution, and the second parameter σ2 is a variance of the random variables. Therefore, the normal distribution is described as N(μ, σ2). The probability law of the random variables complying with the normal distribution is: The probability of a value near μ is large, and the probability of a value far away from μ is small; when σ is less, the distribution is more centralized around μ; when σ is greater, distribution is more decentralized.

Assuming that a standard deviation of the port number of the sampled traffic, which is obtained by calculation, is 310.2418 (σ), and that an arithmetic mean is 2500 (μ), a probability density may be shown in the following table:

| Formula | Lower Limit | Upper Limit | Probability Density |
|---|---|---|---|
| μ ± σ | 2189.758 | 2810.242 | 68.3% |
| μ ± 2σ | 1879.516 | 3120.484 | 95.4% |
| μ ± 3σ | 1569.274 | 3430.726 | 99.7% |

Because the port number of network traffic A is 2457, and falls within [2189.758, 2810.242], the similarity 68.3% between the port of network traffic A and the port of the sampled traffic may be obtained.

Certainly, the manner of calculating the similarity between the port of network traffic A and the port of the sampled traffic is limited to the foregoing manner.

304. Perform weighted harmonic averaging for calculated similarities that are corresponding to the dimensions, to obtain a matching similarity between network traffic A and the sampled traffic.

For example, assuming that set weights of the similarity of the payload content, similarity of the packet length, and similarity of the port are 6, 3, and 1 respectively, the matching similarity calculated by weighted harmonic averaging is as follows:

$$\begin{matrix}Matching similarity = ( PayloadSR 6 ⋆ {LengthSR}^{⋀} 3 ⋆ {PortSR}^{⋀} 1 ) 0.1 \\ = ( 0.42046 \; 6 ⋆ {0.881}^{⋀} 3 ⋆ {0.683}^{⋀} 1 ) 0.1 \\ = 0.550976\end{matrix}$$

Certainly, the set weights of the similarity of the payload content, similarity of the packet length, and similarity of the port may also be 3, 3, and 1 respectively or other values, and the manner of calculating the matching similarity by weighted harmonic averaging is similar.

305. Determine whether the matching similarity obtained by calculation is greater than a similarity threshold.

If yes, step 306 is performed; otherwise, step 307 is performed.

306. Output an identification result indicating successful identification.

Assuming that network traffic A belongs to traffic in a package, a related device may be instructed not to perform separate charging.

307. Output an identification result indicating failed identification.

In the foregoing scenario, the similarities between network traffic A and the sampled traffic are calculated mainly according to three dimensions: the port number, the packet length, and the payload content. Other scenarios in which the similarities between network traffic A and the sampled traffic are calculated according to the dimensions may be deduced in the same way.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, in the solution of this embodiment, DPI identification is first performed for unknown traffic; if the DPI identification fails, similarities between the unknown traffic and sampled traffic are calculated separately according to dimensions such as a port number, a packet length, and payload content; and weighted harmonic averaging is performed for calculated similarities that are corresponding to the dimensions, to obtain a matching similarity between the unknown traffic and the sampled traffic. A mechanism that may use a traffic analysis device to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

For better implementing the foregoing solution of the embodiment of the present invention, the following further provides a related apparatus for implementing the foregoing solution.

Referring to FIG. 5, an embodiment of the present invention further provides a similarity matching server 500, which may include:

an obtaining unit 510 and a similarity calculating unit 520.

The obtaining unit 510 is configured to obtain unknown traffic.

The similarity calculating unit 520 is configured to separately calculate, according to N dimensions, similarities between sampled traffic and the unknown traffic obtained by the obtaining unit; and perform weighted harmonic averaging for calculated similarities that are corresponding to the dimensions, to obtain a matching similarity between the unknown traffic and the sampled traffic, where, N is an integer greater than or equal to 2.

In some embodiments of the present invention, the similarity calculating unit 520 may be specifically configured to separately calculate the similarities between the unknown traffic and the sampled traffic according to the N dimensions when the unknown traffic fails to be identified based on a deep packet inspection technology; and perform weighted harmonic averaging for the calculated similarities that are corresponding to the dimensions, to obtain the matching similarity between the unknown traffic and the sampled traffic, where, N is an integer greater than or equal to 2.

The N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

The similarity calculating unit 520 may select, according to actual requirements, a dimension used for identification. Selected dimensions may vary according to different application scenarios and different accuracy requirements. For example, the similarity calculating unit 520 may select at least two dimensions from the following dimensions to calculate the similarities between the unknown traffic and the sampled traffic: packet payload content, a packet length, a packet port number, a packet transmission rate, an uplink packet quantity, a downlink packet quantity, a ratio of the uplink packet quantity to the downlink packet quantity, an uplink traffic volume, a downlink traffic volume, a ratio of the uplink traffic volume to the downlink traffic volume, a traffic volume of first M packets, and so on. Certainly, the embodiment of the present invention is not limited to the foregoing similarity comparison dimensions, and other dimensions may also be introduced.

In some embodiments of the present invention, in respect of the separately calculating similarities between the unknown traffic and sampled traffic according to N dimensions, the similarity calculating unit 520 may be specifically configured to perform at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic;

calculating a similarity between a traffic volume of first M packets of the unknown traffic and a traffic volume of first M packets of the sampled traffic; and

performing weighted harmonic averaging for at least two similarities obtained by calculation, to obtain the matching similarity between the unknown traffic and the sampled traffic.

In some embodiments of the present invention, in respect of the calculating a similarity between packet payload content of the unknown traffic and packet payload content of the sampled traffic, the similarity calculating unit 520 may be specifically configured to:

calculate a similarity between characters of the packet payload content of the unknown traffic and characters of the packet payload content of the sampled traffic;

calculate a matching degree between the packet payload content of the unknown traffic and the packet payload content of the sampled traffic; and

calculate a product of a square root of the matching degree and the character similarity, where the product is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the similarity calculating unit 520 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the similarity calculating unit 520 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic and a packet length of the sampled traffic, the similarity calculating unit 520 may be specifically configured to divide the packet length of the unknown traffic by the packet length of the sampled traffic to obtain a quotient, where the quotient is the similarity between the packet length of the unknown traffic and the packet length of the sampled traffic; or, determine a first length interval within which the packet length of the unknown traffic falls, and determine, according to a correspondence relationship between a length interval and a similarity value, a similarity value corresponding to the first length interval, where the similarity value corresponding to the first length interval is the similarity between the packet length of the unknown traffic and the packet length of the sampled traffic.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

It may be understood that the similarity matching apparatus 500 in this embodiment may be used to implement a part or all of the technical solutions in the foregoing method embodiments. The functions of each functional unit of the similarity matching apparatus 500 may be implemented according to the method in the foregoing method embodiments. The specific implementation process is not further described herein. For details, reference may be made to related descriptions in the foregoing embodiments.

As can be seen from the above, in the solution of this embodiment, after obtaining unknown traffic, the similarity matching apparatus 500 separately calculates similarities between the unknown traffic and sampled traffic according to N dimensions; and performs weighted harmonic averaging for calculated similarities that are corresponding to the dimensions, to obtain a matching similarity between the unknown traffic and the sampled traffic, where, N is an integer greater than or equal to 2. A mechanism that may use the similarity matching apparatus 500 to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

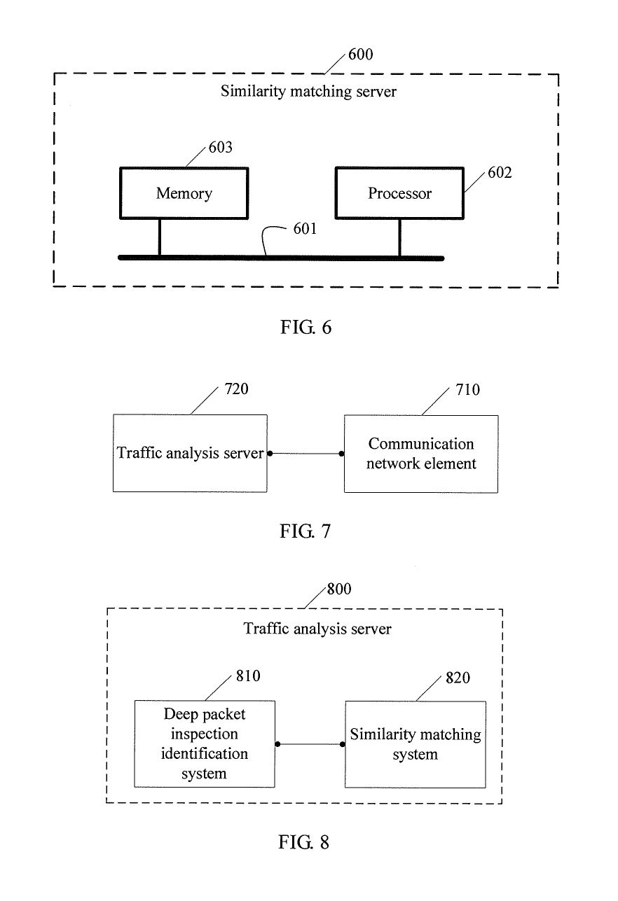

FIG. 6 is a schematic structural diagram of a similarity matching server 600 according to an embodiment of the present invention. As shown in FIG. 6, the similarity matching server 600 of this embodiment includes at least one bus 601, at least one processor 602 connected to the bus 601, and at least one memory 603 connected to the bus 601.

The processor 602 invokes, through the bus 601, code stored in the memory 603, to obtain unknown traffic; and separately calculates similarities between the unknown traffic and sampled traffic according to N dimensions; and performs weighted harmonic averaging for calculated similarities that are corresponding to the dimensions, to obtain a matching similarity between the unknown traffic and the sampled traffic, where, N is an integer greater than or equal to 2.

The N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

The processor 602 may obtain traffic of multiple devices in the network by deployment. For example, the similarity matching server 600 may be a card or a software module, and the similarity matching server 600 may be embedded into a network element such as a base station controller or a data gateway. Alternatively, the similarity matching server 600 may be used as an independent device, and may be connected externally or in series or in other manners to access a network.

In some embodiments of the present invention, the processor 602 may separately calculate the similarities between the unknown traffic and the sampled traffic according to the N dimensions when the unknown traffic fails to be identified based on a deep packet inspection technology; and perform weighted harmonic averaging for the calculated similarities that are corresponding to the dimensions, to obtain the matching similarity between the unknown traffic and the sampled traffic, where, N is an integer greater than or equal to 2.

In some embodiments of the present invention, if the obtained matching similarity between the sampled traffic and the unknown traffic is greater than a set similarity threshold, the processor 602 may output a traffic identification result indicating successful matching between the unknown traffic and the sampled traffic (where the traffic identification result may indicate, for example, that the unknown traffic and the sampled traffic are of a same service type. In this case, charging for the unknown traffic may be performed according to a package charging mode corresponding to the service type of the sampled traffic. For example, an Fk1 package service exists, all traffic for a user to access the Fk1 is free, and separate charging is performed for external video traffic and advertisement traffic of the Fk1. Other service scenarios are deduced in the same way). In addition, if the obtained matching similarity between the sampled traffic and the unknown traffic is less than the set similarity threshold, the processor 602 may output a traffic identification result indicating failed matching between the unknown traffic and the sampled traffic.

The processor 602 may select, according to actual requirements, a dimension used for identification. Selected dimensions may vary according to different application scenarios and different accuracy requirements. For example, the processor 602 may select at least two dimensions from the following dimensions to calculate the similarities between the unknown traffic and the sampled traffic: packet payload content, a packet length, a packet port number, a packet transmission rate, an uplink packet quantity, a downlink packet quantity, a ratio of the uplink packet quantity to the downlink packet quantity, an uplink traffic volume, a downlink traffic volume, a ratio of the uplink traffic volume to the downlink traffic volume, a traffic volume of first M packets, and so on. Certainly, the embodiment of the present invention is not limited to the foregoing similarity comparison dimensions, and other dimensions may also be introduced.

In some embodiments of the present invention, in respect of the separately calculating similarities between the unknown traffic and sampled traffic according to N dimensions, the processor 602 may be specifically configured to perform at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic; and calculating a similarity between a traffic volume of first M packets of the unknown traffic and a traffic volume of first M packets of the sampled traffic.

In an actual application, multiple manners compliant with the computation logic in the field may be used to calculate a similarity between the unknown traffic and the sampled traffic according to a corresponding dimension. For example, in respect of the calculating a similarity between packet payload content of the unknown traffic and packet payload content of the sampled traffic, the processor 602 may be specifically configured to: calculate a similarity between characters of the packet payload content of the unknown traffic and characters of the packet payload content of the sampled traffic; calculate a matching degree between the packet payload content of the unknown traffic and the packet payload content of the sampled traffic; and calculate a product of a square root of the matching degree and the character similarity, where the product is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the processor 602 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the processor 602 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic and a packet length of the sampled traffic, the processor 602 may be specifically configured to divide the packet length of the unknown traffic by the packet length of the sampled traffic to obtain a quotient, where the quotient is the similarity between the packet length of the unknown traffic and the packet length of the sampled traffic; or, determine a first length interval within which the packet length of the unknown traffic falls, and determine, according to a correspondence relationship between a length interval and a similarity value, a similarity value corresponding to the first length interval, where the similarity value corresponding to the first length interval is the similarity between the packet length of the unknown traffic and the packet length of the sampled traffic.

Manners of calculating similarities corresponding to other dimensions may be deduced in the same way, and are not further enumerated one by one herein.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

It may be understood that the similarity matching server 600 in this embodiment may be used to implement a part or all of the technical solutions in the foregoing method embodiments. The functions of each functional unit of the similarity matching apparatus 600 may be implemented according to the method in the foregoing method embodiments. The specific implementation process is not further described herein. For details, reference may be made to related descriptions in the foregoing embodiments.

As can be seen from the above, in the solution of the embodiment of the present invention, after obtaining unknown traffic, the processor 602 separately calculates similarities between the unknown traffic and sampled traffic according to N dimensions; and performs weighted harmonic averaging for calculated similarities that are corresponding to the dimensions, to obtain a matching similarity between the unknown traffic and the sampled traffic, where, N is an integer greater than or equal to 2. A mechanism that uses the similarity matching server 600 to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

Referring to FIG. 7, an embodiment of the present invention further provides a communication system, including:

a communication network element 710 and a traffic analysis server 720 connected to the communication network element 710.

The communication network element 710 is configured to receive unknown traffic.

The traffic analysis server 720 is configured to obtain the unknown traffic received by the communication network element 710 or obtain a mirror of the unknown traffic received by the communication network element 710; separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where N is an integer greater than or equal to 2.

The traffic analysis server 720 may be embedded into the communication network element 710 (a network element such as a base station controller or a data gateway). Alternatively, the traffic analysis server 720 may be used as an independent device, and may be connected externally or in series or in other manners to access a network to connect to the communication network element 710.

The N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

It may be understood that the communication network element of this embodiment may be, for example, a network element that may be used to transmit service traffic in the network, for example, a base station controller, a gateway, or various data servers.

In some embodiments of the present invention, the traffic analysis server 720 may be specifically configured to: when the unknown traffic or the mirror of the unknown traffic fails to be identified based on a deep packet inspection technology, separately calculate the similarities between the unknown traffic or the mirror of the unknown traffic and the sampled traffic according to the N dimensions; and perform weighted harmonic averaging for the calculated similarities that are corresponding to the dimensions, to obtain the matching similarity between the unknown traffic or the mirror of the unknown traffic and the sampled traffic, where, N is an integer greater than or equal to 2.

In some embodiments of the present invention, if the obtained matching similarity between the sampled traffic and the unknown traffic or the mirror of the unknown traffic is greater than a set similarity threshold, the traffic analysis server 720 may output a traffic identification result indicating successful matching between the unknown traffic or the mirror of the unknown traffic and the sampled traffic to the communication network element 710 or other communication network elements (where the traffic identification result may indicate, for example, that the unknown traffic or the mirror of the unknown traffic and the sampled traffic are of a same service type. In this case, charging for the unknown traffic or the mirror of the unknown traffic may be performed according to a package charging mode corresponding to the service type of the sampled traffic. For example, an Fk1 package service exists, all traffic for a user to access the Fk1 is free, and separate charging is performed for external video traffic and advertisement traffic of the Fk1. Other service scenarios are deduced in the same way). In addition, if the obtained matching similarity between the sampled traffic and the unknown traffic or the mirror of the unknown traffic is less than the set similarity threshold, the traffic analysis server 720 may output a traffic identification result indicating failed matching between the unknown traffic or the mirror of the unknown traffic and the sampled traffic to the communication network element 710 or other communication network elements.

A dimension used for identification may be selected according to actual requirements. Selected dimensions may vary according to different application scenarios and different accuracy requirements. For example, at least two dimensions may be selected from the following dimensions to calculate the similarities between the unknown traffic or the mirror of the unknown traffic and the sampled traffic: packet payload content, a packet length, a packet port number, a packet transmission rate, an uplink packet quantity, a downlink packet quantity, a ratio of the uplink packet quantity to the downlink packet quantity, an uplink traffic volume, a downlink traffic volume, a ratio of the uplink traffic volume to the downlink traffic volume, a traffic volume of first M packets, and so on. Certainly, the embodiment of the present invention is not limited to the foregoing similarity comparison dimensions, and other dimensions may also be introduced.

In some embodiments of the present invention, in respect of the separately calculating similarities between the unknown traffic or the mirror of the unknown traffic and sampled traffic according to N dimensions, the traffic analysis server 720 may be specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

In an actual application, multiple manners compliant with the computation logic in the field may be used to calculate a similarity between the unknown traffic or the mirror of the unknown traffic and the sampled traffic according to a corresponding dimension. For example, in respect of the calculating a similarity between packet payload content of the unknown traffic or the mirror of the unknown traffic and packet payload content of the sampled traffic, the traffic analysis server 720 may be specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic.

In some other embodiments of the present invention, in respect of the calculating a similarity between packet payload content of the unknown traffic or the mirror of the unknown traffic and packet payload content of the sampled traffic, the traffic analysis server 720 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the traffic analysis server 720 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic or the mirror of the unknown traffic and a packet length of the sampled traffic, the traffic analysis server 720 may be specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

Manners of calculating similarities corresponding to other dimensions may be deduced in the same way, and are not further enumerated one by one herein.

As can be seen from the above, in the solution of this embodiment, after obtaining unknown traffic from the communication network element 710, the traffic analysis server 720 separately calculates similarities between the unknown traffic and sampled traffic according to N dimensions; and performs weighted harmonic averaging for calculated similarities that are corresponding to the dimensions, to obtain a matching similarity between the unknown traffic and the sampled traffic, where, N is an integer greater than or equal to 2. A mechanism that may use a traffic analysis server to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by this embodiment selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

Referring to FIG. 8, an embodiment of the present invention further provides a traffic analysis server 800, which may include: a deep packet inspection identification system 810 and a similarity matching system 820.

The deep packet inspection identification system 810 is configured to obtain unknown traffic, and identify the unknown traffic based on a deep packet inspection technology.

The similarity matching system 820 is configured to separately calculate similarities between the unknown traffic and sampled traffic according to N dimensions when the deep packet inspection identification system 810 fails to identify the unknown traffic based on the deep packet inspection technology; and perform weighted harmonic averaging for calculated similarities that are corresponding to the dimensions, to obtain a matching similarity between the unknown traffic and the sampled traffic, where, N is an integer greater than or equal to 2, and the N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

In some embodiments of the present invention, the separately calculating similarities between the unknown traffic and sampled traffic by the similarity matching system 820 according to N dimensions may include: performing at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic; and

calculating a similarity between a traffic volume of first M packets of the unknown traffic and a traffic volume of first M packets of the sampled traffic.

In some embodiments of the present invention, in respect of the calculating a similarity between packet payload content of the unknown traffic and packet payload content of the sampled traffic, the similarity matching system 820 may be specifically configured to: calculate a similarity between characters of the packet payload content of the unknown traffic and characters of the packet payload content of the sampled traffic; calculate a matching degree between the packet payload content of the unknown traffic and the packet payload content of the sampled traffic; and calculate a product of a square root of the matching degree and the character similarity, where the product obtained by calculation is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the similarity matching system 820 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the similarity matching system 820 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic and a packet length of the sampled traffic, the similarity matching system 820 may be specifically configured to: divide the packet length of the unknown traffic by the packet length of the sampled traffic to obtain a quotient, where the quotient is the similarity between the packet length of the unknown traffic and the packet length of the sampled traffic; or, determine a first length interval within which the packet length of the unknown traffic falls, and determine, according to a correspondence relationship between a length interval and a similarity value, a similarity value corresponding to the first length interval, where the similarity value corresponding to the first length interval is the similarity between the packet length of the unknown traffic and the packet length of the sampled traffic.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, in the solution of the embodiment of the present invention, after obtaining unknown traffic, the deep packet inspection identification system 810 identifies the unknown traffic based on a deep packet inspection technology; and when the deep packet inspection identification system 810 fails to identify the unknown traffic based on the deep packet inspection technology, the similarity matching system 820 separately calculates similarities between the unknown traffic and sampled traffic according to N dimensions, and performs weighted harmonic averaging for calculated similarities that are corresponding to the dimensions, to obtain a matching similarity between the unknown traffic and the sampled traffic, where N is an integer greater than or equal to 2. A mechanism that may use a device to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

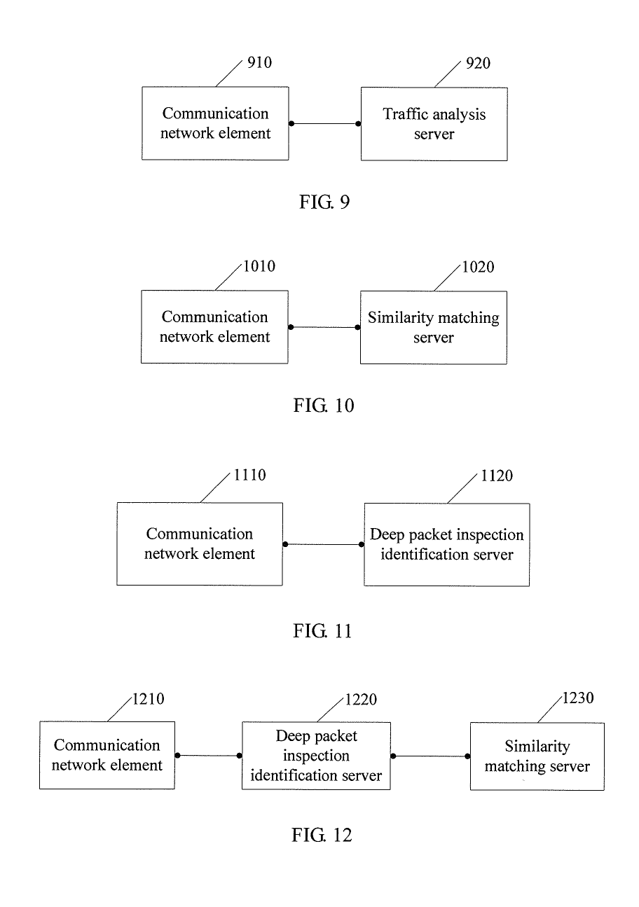

Referring to FIG. 9, an embodiment of the present invention further provides a communication system, which may include:

a communication network element 910 and a traffic analysis server 920.

The communication network element 910 is configured to receive unknown traffic.

The traffic analysis server 920 is configured to obtain the unknown traffic received by the communication network element 910 or obtain a mirror of the unknown traffic received by the communication network element 910, and identify the unknown traffic or the mirror of the unknown traffic based on a deep packet inspection technology; when the traffic analysis server 920 fails to identify the unknown traffic or the mirror of the unknown traffic based on the deep packet inspection technology, separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, N is an integer greater than or equal to 2, and the N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

It may be understood that the communication network element of this embodiment may be, for example, a network element that may be used to transmit service traffic in the network, for example, a base station controller, a gateway, or various data servers.

In some embodiments of the present invention, the separately calculating similarities between the unknown traffic or the mirror of the unknown traffic and sampled traffic by the traffic analysis server 920 according to N dimensions includes: performing at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

In some embodiments of the present invention, in respect of the calculating a similarity between packet payload content of the unknown traffic or the mirror of the unknown traffic and packet payload content of the sampled traffic, the traffic analysis server 920 may be specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the traffic analysis server 920 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the traffic analysis server 920 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic or the mirror of the unknown traffic and a packet length of the sampled traffic, the traffic analysis server 920 may be specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

It may be understood that content of the unknown traffic and content of the mirror of the unknown traffic are basically the same, and that the matching similarity between the unknown traffic and the sampled traffic is equal to the matching similarity between the mirror of the unknown traffic and the sampled traffic.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, in the solution of the embodiment of the present invention, after obtaining unknown traffic from the communication network element 910, the traffic analysis server 920 identifies the unknown traffic based on a deep packet inspection technology; and when the unknown traffic fails to be identified based on the deep packet inspection technology, the traffic analysis server 920 separately calculates similarities between the unknown traffic and sampled traffic according to N dimensions, and performs weighted harmonic averaging for calculated similarities that are corresponding to the dimensions, to obtain a matching similarity between the unknown traffic and the sampled traffic, where N is an integer greater than or equal to 2. A mechanism that may use a device to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

Referring to FIG. 10, an embodiment of the present invention further provides a communication system, which may include:

a communication network element 1010 and a similarity matching server 1020.

The communication network element 1010 is configured to receive unknown traffic, identify the unknown traffic based on a deep packet inspection technology, and if the unknown traffic fails to be identified, send the unidentified unknown traffic or a mirror of the unidentified unknown traffic to the similarity matching server 1020.

The similarity matching server 1020 is configured to receive the unidentified unknown traffic or the mirror of the unknown traffic from the communication network element 1010, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, N is an integer greater than or equal to 2, and the N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

It may be understood that content of the unknown traffic and content of the mirror of the unknown traffic are basically the same, and that the matching similarity between the unknown traffic and the sampled traffic is equal to the matching similarity between the mirror of the unknown traffic and the sampled traffic.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

It may be understood that the communication network element of this embodiment may be, for example, a network element that may be used to transmit service traffic in the network, for example, a base station controller, a gateway, or various data servers.

In some embodiments of the present invention, in respect of the separately calculating similarities between the unknown traffic or the mirror of the unknown traffic and sampled traffic according to N dimensions, the similarity matching server 1020 may be specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

In some embodiments of the present invention, in respect of the calculating a similarity between packet payload content of the unknown traffic or the mirror of the unknown traffic and packet payload content of the sampled traffic, the similarity matching server 1020 may be specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the similarity matching server 1020 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic

In some other embodiments of the present invention, in respect of the calculating a similarity between packet payload content of the unknown traffic and packet payload content of the sampled traffic, the similarity matching server 1020 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic or the mirror of the unknown traffic and a packet length of the sampled traffic, the similarity matching server 1020 may be specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, in the solution of the embodiment of the present invention, after receiving unknown traffic, the communication network element 1010 identifies the unknown traffic based on a deep packet inspection technology; and when the unknown traffic fails to be identified based on the deep packet inspection technology, the similarity matching server 1020 separately calculates similarities between the unknown traffic and sampled traffic according to N dimensions, and performs weighted harmonic averaging for calculated similarities that are corresponding to the dimensions, to obtain a matching similarity between the unknown traffic and the sampled traffic, where N is an integer greater than or equal to 2. A mechanism that may use a device to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

Referring to FIG. 11, an embodiment of the present invention further provides a communication system, which may include:

a communication network element 1110 and a deep packet inspection identification server 1120.

The communication network element 1110 is configured to receive unknown traffic.

The deep packet inspection identification server 1120 is configured to obtain the unknown traffic received by the communication network element 1110 or obtain a mirror of the unknown traffic received by the communication network element 1110; and identify the unknown traffic from the communication network element 1110 based on a deep packet inspection technology, and if the unknown traffic fails to be identified, send the unidentified unknown traffic or the mirror of the unidentified unknown traffic to the communication network element 1110.

The communication network element 1110 is further configured to receive the unidentified unknown traffic or the mirror of the unknown traffic from the deep packet inspection identification server 1120, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, N is an integer greater than or equal to 2, and the N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

It may be understood that content of the unknown traffic and content of the mirror of the unknown traffic are basically the same, and that the matching similarity between the unknown traffic and the sampled traffic is equal to the matching similarity between the mirror of the unknown traffic and the sampled traffic.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

It may be understood that the communication network element 1110 of this embodiment may be, for example, a network element that may be used to transmit service traffic in the network, for example, a base station controller, a gateway, or various data servers.

In some embodiments of the present invention, in respect of the separately calculating similarities between the unknown traffic or the mirror of the unknown traffic and sampled traffic according to N dimensions, the communication network element 1110 may be specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

In some embodiments of the present invention, in respect of the calculating a similarity between packet payload content of the unknown traffic or the mirror of the unknown traffic and packet payload content of the sampled traffic, the communication network element 1110 may be specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the communication network element 1110 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the communication network element 1110 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic or the mirror of the unknown traffic and a packet length of the sampled traffic, the communication network element 1110 may be specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, in the solution of the embodiment of the present invention, the deep packet inspection identification server 1120 obtains unknown traffic from the communication network element 1110, and identifies the unknown traffic from the communication network element 1110 based on a deep packet inspection technology, and if the unknown traffic fails to be identified, the deep packet inspection identification server 1120 sends the unidentified unknown traffic to the communication network element 1110; and after receiving the unknown traffic, the communication network element 1110 separately calculates similarities between the unknown traffic and sampled traffic according to N dimensions, and the communication network element 1110 performs weighted harmonic averaging for calculated similarities that are corresponding to the dimensions, to obtain a matching similarity between the unknown traffic and the sampled traffic, where, N is an integer greater than or equal to 2. A mechanism that may use a device to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

Referring to FIG. 12, an embodiment of the present invention further provides a communication system, which may include:

a communication network element 1210, a deep packet inspection identification server 1220, and a similarity matching server 1230.

The communication network element 1210 is configured to receive unknown traffic.

The deep packet inspection identification server 1220 is configured to obtain the unknown traffic received by the communication network element 1210 or obtain a mirror of the unknown traffic received by the communication network element 1210; and identify, based on a deep packet inspection technology, the unknown traffic or the mirror of the unknown traffic received by the communication network element 1210, and if the unknown traffic or the mirror of the unknown traffic fails to be identified, send the unidentified unknown traffic or the mirror of the unidentified unknown traffic to the similarity matching server 1230.

The similarity matching server 1230 is configured to receive the unidentified unknown traffic or the mirror of the unknown traffic from the deep packet inspection identification server 1220, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, where, the N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

It may be understood that content of the unknown traffic and content of the mirror of the unknown traffic are basically the same, and that the matching similarity between the unknown traffic and the sampled traffic is equal to the matching similarity between the mirror of the unknown traffic and the sampled traffic.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

It may be understood that the communication network element of this embodiment may be, for example, a network element that may be used to transmit service traffic in the network, for example, a base station controller, a gateway, or various data servers.

In some embodiments of the present invention, in respect of the separately calculating similarities between the unknown traffic or the mirror of the unknown traffic and sampled traffic according to N dimensions, the similarity matching server 1230 may be specifically configured to perform at least two of the following similarity calculation operations:

calculating a similarity between a packet length of the unknown traffic or the mirror of the unknown traffic and a packet length of the sampled traffic;

calculating a similarity between packet payload content of the unknown traffic or the mirror of the unknown traffic and packet payload content of the sampled traffic;

calculating a similarity between a packet port number of the unknown traffic or the mirror of the unknown traffic and a packet port number of the sampled traffic;

calculating a similarity between a packet transmission rate of the unknown traffic or the mirror of the unknown traffic and a packet transmission rate of the sampled traffic;

calculating a similarity between an uplink packet quantity of the unknown traffic or the mirror of the unknown traffic and an uplink packet quantity of the sampled traffic;

calculating a similarity between a downlink packet quantity of the unknown traffic or the mirror of the unknown traffic and a downlink packet quantity of the sampled traffic;

calculating a similarity between a ratio of the uplink packet quantity to the downlink packet quantity of the unknown traffic or the mirror of the unknown traffic and a ratio of the uplink packet quantity to the downlink packet quantity of the sampled traffic;

calculating a similarity between an uplink traffic volume of the unknown traffic or the mirror of the unknown traffic and an uplink traffic volume of the sampled traffic;

calculating a similarity between a downlink traffic volume of the unknown traffic or the mirror of the unknown traffic and a downlink traffic volume of the sampled traffic;

calculating a similarity between a ratio of the uplink traffic volume to the downlink traffic volume of the unknown traffic or the mirror of the unknown traffic and a ratio of the uplink traffic volume to the downlink traffic volume of the sampled traffic; and

calculating a similarity between a traffic volume of first M packets of the unknown traffic or the mirror of the unknown traffic and a traffic volume of first M packets of the sampled traffic.

In some embodiments of the present invention, in respect of the calculating a similarity between packet payload content of the unknown traffic or the mirror of the unknown traffic and packet payload content of the sampled traffic, the similarity matching server 1230 may be specifically configured to: calculate a similarity between characters of the packet payload content of the unknown traffic or the mirror of the unknown traffic and characters of the packet payload content of the sampled traffic; calculate a matching degree between the packet payload content of the unknown traffic or the mirror of the unknown traffic and the packet payload content of the sampled traffic; and calculate a product of a square root of the matching degree and the character similarity, where the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, where the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the similarity matching server 1230 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the similarity matching server 1230 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic or the mirror of the unknown traffic and a packet length of the sampled traffic, the similarity matching server 1230 may be specifically configured to: divide the packet length of the unknown traffic or the mirror of the unknown traffic by the packet length of the sampled traffic to obtain a quotient, where the quotient is the similarity between the packet length of the unknown traffic or the mirror of the unknown traffic and the packet length of the sampled traffic; or, determine a first length interval within which the packet length of the unknown traffic or the mirror of the unknown traffic falls, and determine, according to a correspondence relationship between a length interval and a similarity value, a similarity value corresponding to the first length interval, where the similarity value corresponding to the first length interval is the similarity between the packet length of the unknown traffic or the mirror of the unknown traffic and the packet length of the sampled traffic.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, in the solution of the embodiment of the present invention, the deep packet inspection identification server 1220 obtains unknown traffic from the communication network element 1210, and identifies the unknown traffic from the communication network element 1010 based on a deep packet inspection technology, and if the unknown traffic fails to be identified, the deep packet inspection identification server 1220 sends the unidentified unknown traffic to the similarity matching server 1230; and after receiving the unknown traffic, the similarity matching server 1230 separately calculates similarities between the unknown traffic and sampled traffic according to N dimensions, and performs weighted harmonic averaging for calculated similarities that are corresponding to the dimensions, to obtain a matching similarity between the unknown traffic and the sampled traffic, where, N is an integer greater than or equal to 2. A mechanism that may use a device to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

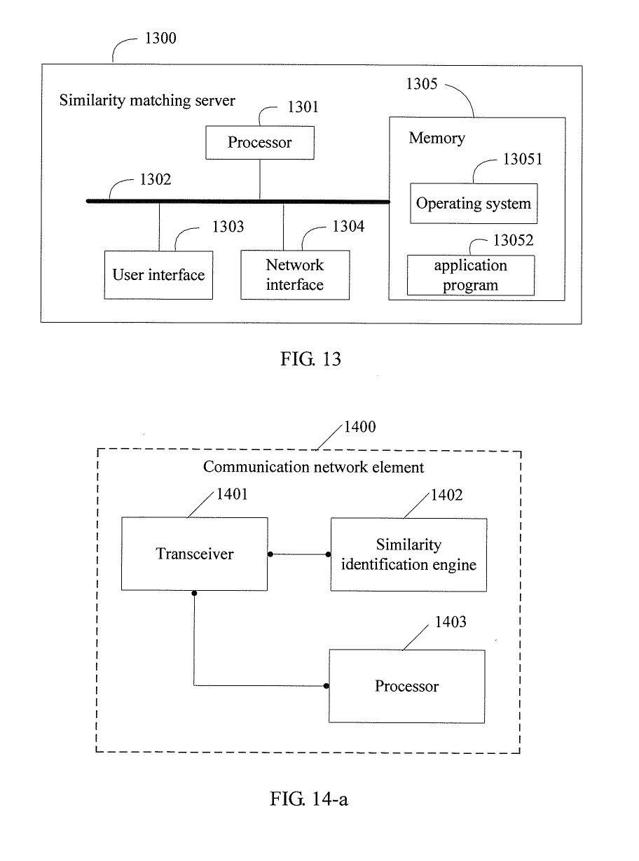

FIG. 13 shows a structure of a similarity matching server 1300 according to an embodiment of the present invention. The similarity matching server 1300 includes: at least one processor 1301, for example, a central processing unit (CPU), at least one network interface 1304 or a user interfaces 1303, a memory 1305, and at least one communication bus 1302. The communication bus 1302 is configured to implement connection and communication between the components. The similarity matching server 1300 optionally includes a user interface 1303, including a display, a keyboard, or a clicking device (for example, a mouse, a trackball (trackball), a touch pad, or a touch screen). The memory 1305 may include a high-speed RAM memory, and may also include a non-volatile memory (non-volatile memory), for example, at least one disk memory. The memory 1305 may optionally include a storage apparatus located far away from the processor 1301.

In some implementation manners, the memory 1305 stores the following elements: an executable module or a data structure, or a subset thereof, or an extension set thereof:

an operating system 13051, including various system programs and configured to implement various basic services and process hardware-based tasks; and

an application program module 13052, including various application programs and configured to implement various application services.

The application program module 13052 includes but is not limited to an obtaining unit 510 and a similarity calculating unit 520.

Specific implementation of various modules in the application program module 13052 is not further described herein. For details, reference may be made to the corresponding modules in the embodiment shown in FIG. 5.

In some embodiments of the present invention, by invoking programs or instructions stored in the memory 1305, the processor 1301 may be configured to obtain unknown traffic; and separately calculate similarities between the unknown traffic and sampled traffic according to N dimensions; and perform weighted harmonic averaging for calculated similarities that are corresponding to the dimensions, to obtain a matching similarity between the unknown traffic and the sampled traffic, where, N is an integer greater than or equal to 2.

In some embodiments of the present invention, the processor 1301 may separately calculate the similarities between the unknown traffic and the sampled traffic according to the N dimensions when the unknown traffic fails to be identified based on a deep packet inspection technology; and perform weighted harmonic averaging for the calculated similarities that are corresponding to the dimensions, to obtain the matching similarity between the unknown traffic and the sampled traffic, where, N is an integer greater than or equal to 2.

The N dimensions may include N dimensions of the following dimensions: n1 dimensions related to a packet of the traffic, n2 dimensions related to a session corresponding to the traffic, and n3 dimensions related to the traffic itself, where n1, n2, and n3 are positive integers.

The n1 dimensions related to a packet of the traffic are n1 dimensions using packets (for example, packet headers and/or packet payloads) in the traffic as an analysis angle. The n1 dimensions related to a packet of the traffic may include, for example, using a length of a packet in the traffic as a dimension, using payload content of a packet in the traffic as a dimension, and using a port number of a packet in the traffic as a dimension.

The n2 dimensions related to a session corresponding to the traffic are n2 dimensions using the session corresponding to the traffic as an analysis angle. The n2 dimensions related to the session corresponding to the traffic may include, for example, using an uplink packet quantity of the session corresponding to the traffic as a dimension, using a downlink packet quantity of the session corresponding to the traffic as a dimension, using a ratio of the uplink packet quantity to the downlink packet quantity of the session corresponding to the traffic as a dimension, using an uplink traffic volume of the session corresponding to the traffic as a dimension, using a downlink traffic volume of the session corresponding to the traffic as a dimension, and using a ratio of the uplink traffic volume to the downlink traffic volume of the session corresponding to the traffic as a dimension.

The n3 dimensions related to the traffic itself are n3 dimensions using the traffic itself as an analysis angle. The n3 dimensions are unrelated to the payload of each packet in the traffic, and are also unrelated to the session corresponding to the traffic. The n3 dimensions related to the traffic itself may include, for example, using a traffic volume of first M packets in the traffic as a dimension, using a packet transmission rate of the traffic as a dimension, and so on.

In some embodiments of the present invention, if the obtained matching similarity between the sampled traffic and the unknown traffic is greater than a set similarity threshold, the processor 1301 may output a traffic identification result indicating successful matching between the unknown traffic and the sampled traffic (where the traffic identification result may indicate, for example, that the unknown traffic and the sampled traffic are of a same service type. In this case, charging for the unknown traffic may be performed according to a package charging mode corresponding to the service type of the sampled traffic. For example, an Fk1 package service exists, all traffic for a user to access the Fk1 is free, and separate charging is performed for external video traffic and advertisement traffic of the Fk1. Other service scenarios are deduced in the same way). In addition, if the obtained matching similarity between the sampled traffic and the unknown traffic is less than the set similarity threshold, the processor 1301 may output a traffic identification result indicating failed matching between the unknown traffic and the sampled traffic.

The processor 1301 may select, according to actual requirements, a dimension used for identification. Selected dimensions may vary according to different application scenarios and different accuracy requirements. For example, the processor 1301 may select at least two dimensions from the following dimensions to calculate the similarities between the unknown traffic and the sampled traffic: packet payload content, a packet length, a packet port number, a packet transmission rate, an uplink packet quantity, a downlink packet quantity, a ratio of the uplink packet quantity to the downlink packet quantity, an uplink traffic volume, a downlink traffic volume, a ratio of the uplink traffic volume to the downlink traffic volume, a traffic volume of first M packets, and so on. Certainly, the embodiment of the present invention is not limited to the foregoing similarity comparison dimensions, and other dimensions may also be introduced.

In some embodiments of the present invention, in respect of the separately calculating similarities between the unknown traffic and sampled traffic according to N dimensions, the processor 1301 may be specifically configured to perform at least two of the following similarity calculation operations:

calculating a similarity between a packet length of the unknown traffic and a packet length of the sampled traffic;

calculating a similarity between packet payload content of the unknown traffic and packet payload content of the sampled traffic;

calculating a similarity between a packet port number of the unknown traffic and a packet port number of the sampled traffic;

calculating a similarity between a packet transmission rate of the unknown traffic and a packet transmission rate of the sampled traffic;

calculating a similarity between an uplink packet quantity of the unknown traffic and an uplink packet quantity of the sampled traffic;

calculating a similarity between a downlink packet quantity of the unknown traffic and a downlink packet quantity of the sampled traffic;

calculating a similarity between a ratio of the uplink packet quantity to the downlink packet quantity of the unknown traffic and a ratio of the uplink packet quantity to the downlink packet quantity of the sampled traffic;

calculating a similarity between an uplink traffic volume of the unknown traffic and an uplink traffic volume of the sampled traffic;

calculating a similarity between a downlink traffic volume of the unknown traffic and a downlink traffic volume of the sampled traffic;

calculating a similarity between a ratio of the uplink traffic volume to the downlink traffic volume of the unknown traffic and a ratio of the uplink traffic volume to the downlink traffic volume of the sampled traffic; and

calculating a similarity between a traffic volume of first M packets of the unknown traffic and a traffic volume of first M packets of the sampled traffic.

In an actual application, multiple manners compliant with the computation logic in the field may be used to calculate a similarity between the unknown traffic and the sampled traffic according to a corresponding dimension. For example, in respect of the calculating a similarity between packet payload content of the unknown traffic and packet payload content of the sampled traffic, the processor 1301 may be specifically configured to: calculate a similarity between characters of the packet payload content of the unknown traffic and characters of the packet payload content of the sampled traffic; calculate a matching degree between the packet payload content of the unknown traffic and the packet payload content of the sampled traffic; and calculate a product of a square root of the matching degree and the character similarity, where the product is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, where the differentiation degree is equal to a quantity of characters, in the packet payload content of the sampled traffic, which are different from characters in the packet payload content of the unknown traffic, divided by a total quantity of characters of the packet payload content of the sampled traffic.

In some other embodiments of the present invention, in respect of the calculating a similarity between packet payload content of the unknown traffic and packet payload content of the sampled traffic, the processor 1301 may also be specifically configured to: it is assumed that payload content of the unknown traffic is a string s1, and that payload content of the sampled traffic is a string s2, determine the similarity sim(s1, s2) between the two strings by comparison. Assuming that n different characters are included in the string s1 and string s2, and are c1, c2, . . . , cn respectively, determining the similarity between the strings may be changed to determining an angle between vectors v1 and v2 corresponding to the two strings. A greater cosine value indicates a smaller angle between the vectors v1 and v2 corresponding to the two strings and a greater similarity between the string s1 and string s2, that is, a greater similarity between the payload content of the unknown traffic and the payload content of the sampled traffic. Conversely, a less cosine value indicates a larger angle between the vectors v1 and v2 corresponding to the two strings and a less similarity between the string s1 and string s2, that is, a less similarity between the payload content of the unknown traffic and the payload content of the sampled traffic.

In some other embodiments of the present invention, in respect of the calculating a similarity between packet payload content of the unknown traffic and packet payload content of the sampled traffic, the processor 1301 may also be specifically configured to: it is assumed that payload content of the unknown traffic is a string s1, and that payload content of the sampled traffic is a string s2, use a matrix to record a matching result between two characters corresponding to the two strings in all positions thereof, and if the two characters are matched (the same), record 1, or otherwise, record 0, and then solve one sequence with a longest diagonal in the matrix, where a position corresponding to the sequence is a position of a longest matching substring. For example, a longer longest common substring indicates a greater similarity between two strings, that is, a greater similarity between the payload content of the unknown traffic and the payload content of the sampled traffic. Conversely, a shorter longest common substring indicates a less similarity between two strings, that is, a less similarity between the payload content of the unknown traffic and the payload content of the sampled traffic.

In some embodiments of the present invention, in respect of the calculating a similarity between a packet length of the unknown traffic and a packet length of the sampled traffic, the processor 1301 may be specifically configured to divide the packet length of the unknown traffic by the packet length of the sampled traffic to obtain a quotient, where the quotient is the similarity between the packet length of the unknown traffic and the packet length of the sampled traffic; or, determine a first length interval within which the packet length of the unknown traffic falls, and determine, according to a correspondence relationship between a length interval and a similarity value, a similarity value corresponding to the first length interval, where the similarity value corresponding to the first length interval is the similarity between the packet length of the unknown traffic and the packet length of the sampled traffic.

Manners of calculating similarities corresponding to other dimensions may be deduced in the same way, and are not further enumerated one by one herein.

It may be understood that the similarity matching server 1300 in this embodiment may be used to implement a part or all of the technical solutions in the foregoing method embodiments. The functions of each functional unit of the similarity matching server 1300 may be implemented according to the method in the foregoing method embodiments. The specific implementation process is not further described herein. For details, reference may be made to related descriptions in the foregoing embodiments.

It may be understood that in the foregoing examples, the matching similarity is calculated mainly for a piece of unknown traffic and a piece of sampled traffic. For a scenario in which multiple pieces of sampled traffic exist, a matching similarity between the unknown traffic and each piece of sampled traffic may be calculated in a similar way. Likewise, for a corresponding scenario in which multiple pieces of unknown traffic exist, a matching similarity between each piece of unknown traffic and each piece of sampled traffic may also be separately calculated in a similar way. The specific process is not further described herein.

As can be seen from the above, after the solution is used, after obtaining unknown traffic, the processor 1301 separately calculates similarities between the unknown traffic and sampled traffic according to N dimensions; and performs weighted harmonic averaging for calculated similarities that are corresponding to the dimensions, to obtain a matching similarity between the unknown traffic and the sampled traffic, where, N is an integer greater than or equal to 2. A mechanism that uses the similarity matching server 1300 to analyze similar traffic is provided, which may provide an online analysis capability, help to improve an automation rate and reduce analysis time, and help to improve efficiency of traffic analysis. Because similarities between unknown traffic and sampled traffic are separately calculated according to N dimensions, and the similarities obtained according to the N dimensions are integrated, where the N dimensions include N dimensions of the following dimensions: n1 dimensions related to a packet of the traffic, n2 dimensions related to a session corresponding to the traffic, and n3 dimensions related to the traffic itself, compared with a regular single-dimension matching mechanism, the technical solution put forward by the embodiment of the present invention selects N dimensions from typical dimensions such as n1 dimensions related to a packet of the traffic, n2 dimensions related to a session corresponding to the traffic, and n3 dimensions related to the traffic itself, to perform combinatorial analysis, which helps to greatly improve accuracy of traffic analysis and further helps to provide effective support for charging of related services.

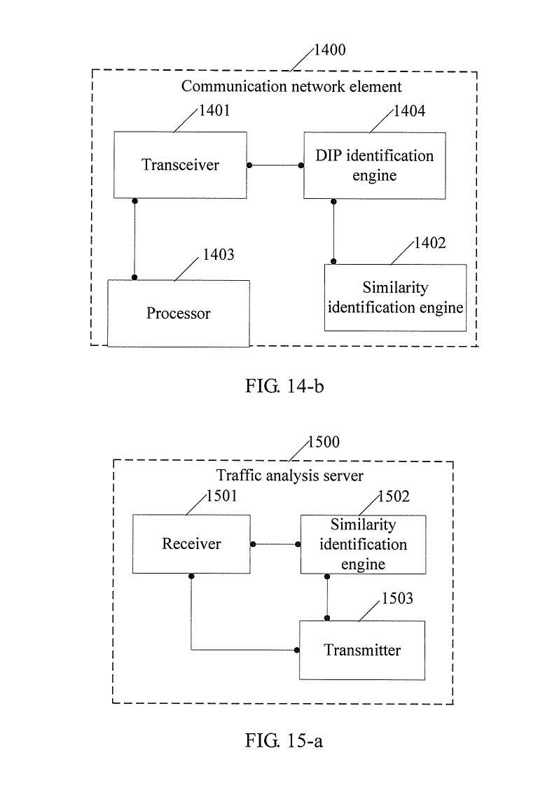

Referring to FIG. 14-a, an embodiment of the present invention further provides a communication network element 1400, including a transceiver 1401 and a processor 1403 coupled with the transceiver and configured to perform network communication. The communication network element 1400 may further include: a similarity identification engine 1402 coupled with the transceiver 1401, where the similarity identification engine 1402 may be, for example, the similarity matching apparatus 500.

In some embodiments of the present invention, as shown in FIG. 14-b, the communication network element 1400 may further include a DPI identification engine 1404 coupled with the transceiver 1401. The DPI identification engine 1404 may be configured to obtain unknown traffic, and identify the unknown traffic based on a deep packet inspection technology.

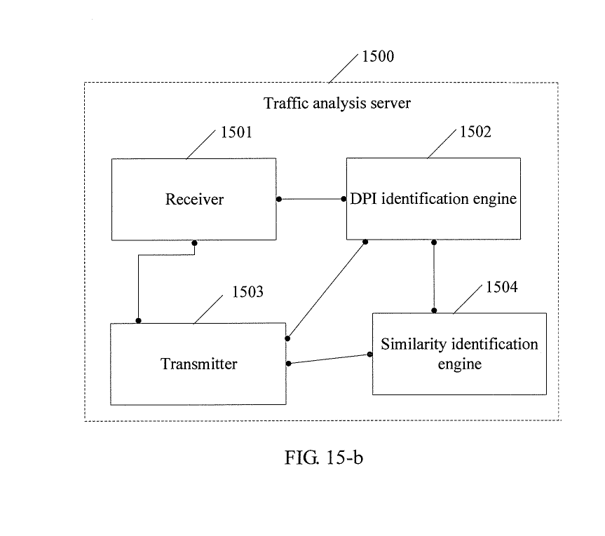

Referring to FIG. 15-a, an embodiment of the present invention further provides a traffic analysis server 1500, where the traffic analysis server 1500 may include: a receiver 1501 configured to receive unknown traffic or a mirror of unknown traffic, a similarity identification engine 1502 coupled with the receiver 1501, and a transmitter 1503 configured to send a matching similarity between the unknown traffic and sampled traffic, or send a matching similarity between the mirror of the unknown traffic and sampled traffic, or send a matching similarity between the unknown traffic output by the similarity identification engine 1502 and sampled traffic, or send a matching similarity between the mirror of the unknown traffic output by the similarity identification engine 1502 and sampled traffic, where the similarity identification engine 1502 may be, for example, the similarity matching apparatus 500.

In some embodiments of the present invention, as shown in FIG. 15-b, the traffic analysis server 1500 may further include a DPI identification engine 1504 coupled with the receiver 1501, where the DPI identification engine 1504 may be configured to obtain unknown traffic or a mirror of unknown traffic, and identify the unknown traffic or the mirror of the unknown traffic based on a deep packet inspection technology.

An embodiment of the present invention further provides a computer storage medium. The computer storage medium may store a program. When being executed, the program performs all or a part of the steps of the similarity matching method or traffic analysis method described in the foregoing method embodiments.

It should be noted that, for ease of description in the method embodiments above, the method is described as a series of actions. Persons skilled in the art should be aware that the present invention is not limited by the described sequence of the actions, because some steps may be performed in any other sequence or performed simultaneously according to the present invention. In addition, persons skilled in the art should be aware that the embodiments in the specification are exemplary embodiments and that actions and modules involved in these embodiments are not mandatory for the present invention.

In the foregoing embodiments, each embodiment has its emphasis. What is not detailed in one embodiment is detailed in the related description of another embodiment.

In the several embodiments provided in the present application, it should be understood that the disclosed apparatus may be implemented in other manners. For example, the described apparatus embodiments are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a read-only memory (ROM, Read-Only Memory), a random access memory (RAM, Random Access Memory), a removable hard disk, a magnetic disk, or an optical disc.

The foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, as long as such modifications or replacements do not cause the essence of corresponding technical solutions to depart from the spirit and scope of the technical solutions of the embodiments of the present invention.

What is claimed is:

1. A similarity matching method, comprising:
obtaining unknown traffic;
separately calculating similarities between the unknown traffic and sampled traffic according to N dimensions; and
performing weighted harmonic averaging for calculated similarities that are corresponding to the dimensions, to obtain a matching similarity between the unknown traffic and the sampled traffic, wherein, N is an integer greater than or equal to 2, and the N dimensions comprise two or more of the following dimensions: n1 dimensions related to a packet of the traffic, n2 dimensions related to a session corresponding to the traffic, and n3 dimensions related to the traffic itself, wherein n1, n2, and n3 are positive integers.

2. The method according to claim 1, wherein separately calculating similarities between the unknown traffic and sampled traffic according to N dimensions comprises: when the unknown traffic fails to be identified based on a deep packet inspection technology, separately calculating the similarities between the unknown traffic and the sampled traffic according to the N dimensions.

3. The method according to claim 1, wherein separately calculating similarities between the unknown traffic and sampled traffic according to N dimensions comprises: performing at least two of the following similarity calculation operations:
calculating a similarity between a packet length of the unknown traffic and a packet length of the sampled traffic;
calculating a similarity between packet payload content of the unknown traffic and packet payload content of the sampled traffic;
calculating a similarity between a packet port number of the unknown traffic and a packet port number of the sampled traffic;
calculating a similarity between a packet transmission rate of the unknown traffic and a packet transmission rate of the sampled traffic;
calculating a similarity between an uplink packet quantity of the unknown traffic and an uplink packet quantity of the sampled traffic;
calculating a similarity between a downlink packet quantity of the unknown traffic and a downlink packet quantity of the sampled traffic;
calculating a similarity between a ratio of the uplink packet quantity to the downlink packet quantity of the unknown traffic and a ratio of the uplink packet quantity to the downlink packet quantity of the sampled traffic;
calculating a similarity between an uplink traffic volume of the unknown traffic and an uplink traffic volume of the sampled traffic;
calculating a similarity between a downlink traffic volume of the unknown traffic and a downlink traffic volume of the sampled traffic;
calculating a similarity between a ratio of the uplink traffic volume to the downlink traffic volume of the unknown traffic and a ratio of the uplink traffic volume to the downlink traffic volume of the sampled traffic; and
calculating a similarity between a traffic volume of first M packets of the unknown traffic and a traffic volume of first M packets of the sampled traffic.

4. The method according to claim 3, wherein calculating a similarity between packet payload content of the unknown traffic and packet payload content of the sampled traffic comprises:
calculating a similarity between characters of the packet payload content of the unknown traffic and characters of the packet payload content of the sampled traffic;
calculating a matching degree between the packet payload content of the unknown traffic and the packet payload content of the sampled traffic; and
calculating a product of a square root of the matching degree and the character similarity, wherein the product obtained by calculation is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, wherein the differentiation degree is equal to a quantity of characters, in the packet payload content of the sampled traffic, which are different from characters in the packet payload content of the unknown traffic, divided by a total quantity of characters of the packet payload content of the sampled traffic.

5. The method according to claim 3, wherein calculating a similarity between a packet length of the unknown traffic and a packet length of the sampled traffic comprises:
dividing the packet length of the unknown traffic by the packet length of the sampled traffic to obtain a quotient, wherein the quotient is the similarity between the packet length of the unknown traffic and the packet length of the sampled traffic; or
determining a first length interval within which the packet length of the unknown traffic falls, and determining, according to a correspondence relationship between a length interval and a similarity value, a similarity value corresponding to the first length interval, wherein the similarity value corresponding to the first length interval is the similarity between the packet length of the unknown traffic and the packet length of the sampled traffic.

6. A traffic analysis server, comprising:
a deep packet inspection identification system, configured to obtain unknown traffic, and identify the unknown traffic based on a deep packet inspection technology; and
a similarity matching system, configured to separately calculate similarities between the unknown traffic and sampled traffic according to N dimensions when the deep packet inspection identification system fails to identify the unknown traffic based on the deep packet inspection technology, and perform weighted harmonic averaging for calculated similarities that are corresponding to the dimensions, to obtain a matching similarity between the unknown traffic and the sampled traffic, wherein, N is an integer greater than or equal to 2, and the N dimensions comprise two or more of the following dimensions: n1 dimensions related to a packet of the traffic, n2 dimensions related to a session corresponding to the traffic, and n3 dimensions related to the traffic itself, wherein n1, n2, and n3 are positive integers.

7. The traffic analysis server according to claim 6, wherein in respect of separately calculating similarities between the unknown traffic and sampled traffic according to N dimensions, the similarity matching system is configured to perform at least two of the following similarity calculation operations:
calculating a similarity between a packet length of the unknown traffic and a packet length of the sampled traffic;
calculating a similarity between packet payload content of the unknown traffic and packet payload content of the sampled traffic;
calculating a similarity between a packet port number of the unknown traffic and a packet port number of the sampled traffic;
calculating a similarity between a packet transmission rate of the unknown traffic and a packet transmission rate of the sampled traffic;
calculating a similarity between an uplink packet quantity of the unknown traffic and an uplink packet quantity of the sampled traffic;
calculating a similarity between a downlink packet quantity of the unknown traffic and a downlink packet quantity of the sampled traffic;
calculating a similarity between a ratio of the uplink packet quantity to the downlink packet quantity of the unknown traffic and a ratio of the uplink packet quantity to the downlink packet quantity of the sampled traffic;
calculating a similarity between an uplink traffic volume of the unknown traffic and an uplink traffic volume of the sampled traffic;
calculating a similarity between a downlink traffic volume of the unknown traffic and a downlink traffic volume of the sampled traffic;
calculating a similarity between a ratio of the uplink traffic volume to the downlink traffic volume of the unknown traffic and a ratio of the uplink traffic volume to the downlink traffic volume of the sampled traffic; and
calculating a similarity between a traffic volume of first M packets of the unknown traffic and a traffic volume of first M packets of the sampled traffic.

8. The traffic analysis server according to claim 7, wherein:
in respect of calculating a similarity between packet payload content of the unknown traffic and packet payload content of the sampled traffic, the similarity matching system is configured to:
calculate a similarity between characters of the packet payload content of the unknown traffic and characters of the packet payload content of the sampled traffic
calculate a matching degree between the packet payload content of the unknown traffic and the packet payload content of the sampled traffic, and
calculate a product of a square root of the matching degree and the character similarity, wherein the product obtained by calculation is the similarity between the packet payload content of the unknown traffic and the packet payload content of the sampled traffic, and the character similarity is equal to a quantity of same characters between the packet payload content of the unknown traffic and the packet payload content of the sampled traffic, divided by a total quantity of characters of the packet payload content of the sampled traffic, and the matching degree is equal to 1 minus a differentiation degree between the packet payload content of the unknown traffic and the packet payload content of the sampled traffic, wherein the differentiation degree is equal to a quantity of characters, in the packet payload content of the sampled traffic, which are different from characters in the packet payload content of the unknown traffic, divided by a total quantity of characters of the packet payload content of the sampled traffic; or
in respect of calculating a similarity between a packet length of the unknown traffic and a packet length of the sampled traffic, the similarity matching system is configured to:
divide the packet length of the unknown traffic by the packet length of the sampled traffic to obtain a quotient, wherein the quotient is the similarity between the packet length of the unknown traffic and the packet length of the sampled traffic, or
determine a first length interval within which the packet length of the unknown traffic falls, and determine, according to a correspondence relationship between a length interval and a similarity value, a similarity value that is corresponding to the first length interval, wherein the similarity value that is corresponding to the first length interval is the similarity between the packet length of the unknown traffic and the packet length of the sampled traffic.

9. A communication system, comprising:
a communication network element: configured to receive unknown traffic; and
a traffic analysis server configured to:
obtain the unknown traffic received by the communication network element or obtain a mirror of the unknown traffic received by the communication network element, and identify the unknown traffic or the mirror of the unknown traffic based on a deep packet inspection technology;
when the unknown traffic or the mirror of the unknown traffic fails to be identified based on the deep packet inspection technology, separately calculate similarities between the unknown traffic or the mirror of the unknown traffic and sampled traffic according to N dimensions; and
perform weighted harmonic averaging for calculated similarities that are corresponding to the dimensions, to obtain a matching similarity between the unknown traffic or the mirror of the unknown traffic and the sampled traffic, wherein, the N dimensions comprise two or more of the following dimensions: n1 dimensions related to a packet of the traffic, n2 dimensions related to a session corresponding to the traffic, and n3 dimensions related to the traffic itself, wherein n1, n2, and n3 are positive integers.

10. The communication system according to claim 9, wherein in respect of separately calculating similarities between the unknown traffic or the mirror of the unknown traffic and sampled traffic according to N dimensions, the traffic analysis server is configured to perform at least two of the following similarity calculation operations:
calculating a similarity between a packet length of the unknown traffic or the mirror of the unknown traffic and a packet length of the sampled traffic;
calculating a similarity between packet payload content of the unknown traffic or the mirror of the unknown traffic and packet payload content of the sampled traffic;
calculating a similarity between a packet port number of the unknown traffic or the mirror of the unknown traffic and a packet port number of the sampled traffic;
calculating a similarity between a packet transmission rate of the unknown traffic or the mirror of the unknown traffic and a packet transmission rate of the sampled traffic;
calculating a similarity between an uplink packet quantity of the unknown traffic or the mirror of the unknown traffic and an uplink packet quantity of the sampled traffic;
calculating a similarity between a downlink packet quantity of the unknown traffic or the mirror of the unknown traffic and a downlink packet quantity of the sampled traffic;
calculating a similarity between a ratio of the uplink packet quantity to the downlink packet quantity of the unknown traffic or the mirror of the unknown traffic and a ratio of the uplink packet quantity to the downlink packet quantity of the sampled traffic;
calculating a similarity between an uplink traffic volume of the unknown traffic or the mirror of the unknown traffic and an uplink traffic volume of the sampled traffic;
calculating a similarity between a downlink traffic volume of the unknown traffic or the mirror of the unknown traffic and a downlink traffic volume of the sampled traffic;
calculating a similarity between a ratio of the uplink traffic volume to the downlink traffic volume of the unknown traffic or the mirror of the unknown traffic and a ratio of the uplink traffic volume to the downlink traffic volume of the sampled traffic; and
calculating a similarity between a traffic volume of first M packets of the unknown traffic or the mirror of the unknown traffic and a traffic volume of first M packets of the sampled traffic.

11. The communication system according to claim 10, wherein:
in respect of calculating a similarity between packet payload content of the unknown traffic or the mirror of the unknown traffic and packet payload content of the sampled traffic, the traffic analysis server is configured to:
calculate a similarity between characters of the packet payload content of the unknown traffic or the mirror of the unknown traffic and characters of the packet payload content of the sampled traffic,
calculate a matching degree between the packet payload content of the unknown traffic or the mirror of the unknown traffic and the packet payload content of the sampled traffic, and
calculate a product of a square root of the matching degree and the character similarity, wherein the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, wherein the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic, or
in respect of calculating a similarity between a packet length of the unknown traffic or the mirror of the unknown traffic and a packet length of the sampled traffic, the traffic analysis server is configured to:
divide the packet length of the unknown traffic or the mirror of the unknown traffic by the packet length of the sampled traffic to obtain a quotient, wherein the quotient is the similarity between the packet length of the unknown traffic or the mirror of the unknown traffic and the packet length of the sampled traffic, or
determine a first length interval within which the packet length of the unknown traffic or the mirror of the unknown traffic falls, and determine, according to a correspondence relationship between a length interval and a similarity value, a similarity value corresponding to the first length interval, wherein the similarity value corresponding to the first length interval is the similarity between the packet length of the unknown traffic or the mirror of the unknown traffic and the packet length of the sampled traffic.

12. A communication system, comprising:
a communication network element and a similarity matching server;
wherein the communication network element is configured to receive unknown traffic, identify the unknown traffic based on a deep packet inspection technology, and if the unknown traffic fails to be identified, send the unidentified unknown traffic or a mirror of the unidentified unknown traffic to the similarity matching server; and
wherein the similarity matching server is configured to receive the unidentified unknown traffic or the mirror of the unknown traffic from the communication network element, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, wherein, N is an integer greater than or equal to 2, and the N dimensions comprise two or more of the following dimensions: n1 dimensions related to a packet of the traffic, n2 dimensions related to a session corresponding to the traffic, and n3 dimensions related to the traffic itself, wherein n1, n2, and n3 are positive integers.

13. The communication system according to claim 12, wherein in respect of separately calculating similarities between the unknown traffic or the mirror of the unknown traffic and sampled traffic according to N dimensions, the similarity matching server is configured to perform at least two of the following similarity calculation operations:
calculating a similarity between a packet length of the unknown traffic or the mirror of the unknown traffic and a packet length of the sampled traffic;
calculating a similarity between packet payload content of the unknown traffic or the mirror of the unknown traffic and packet payload content of the sampled traffic;
calculating a similarity between a packet port number of the unknown traffic or the mirror of the unknown traffic and a packet port number of the sampled traffic;
calculating a similarity between a packet transmission rate of the unknown traffic or the mirror of the unknown traffic and a packet transmission rate of the sampled traffic;
calculating a similarity between an uplink packet quantity of the unknown traffic or the mirror of the unknown traffic and an uplink packet quantity of the sampled traffic;
calculating a similarity between a downlink packet quantity of the unknown traffic or the mirror of the unknown traffic and a downlink packet quantity of the sampled traffic;
calculating a similarity between a ratio of the uplink packet quantity to the downlink packet quantity of the unknown traffic or the mirror of the unknown traffic and a ratio of the uplink packet quantity to the downlink packet quantity of the sampled traffic;
calculating a similarity between an uplink traffic volume of the unknown traffic or the mirror of the unknown traffic and an uplink traffic volume of the sampled traffic;
calculating a similarity between a downlink traffic volume of the unknown traffic or the mirror of the unknown traffic and a downlink traffic volume of the sampled traffic;
calculating a similarity between a ratio of the uplink traffic volume to the downlink traffic volume of the unknown traffic or the mirror of the unknown traffic and a ratio of the uplink traffic volume to the downlink traffic volume of the sampled traffic; and
calculating a similarity between a traffic volume of first M packets of the unknown traffic or the mirror of the unknown traffic and a traffic volume of first M packets of the sampled traffic.

14. The communication system according to claim 13, wherein:
in respect of calculating a similarity between packet payload content of the unknown traffic or the mirror of the unknown traffic and packet payload content of the sampled traffic, the similarity matching server is configured to:
calculate a similarity between characters of the packet payload content of the unknown traffic or the mirror of the unknown traffic and characters of the packet payload content of the sampled traffic,
calculate a matching degree between the packet payload content of the unknown traffic or the mirror of the unknown traffic and the packet payload content of the sampled traffic, and
calculate a product of a square root of the matching degree and the character similarity, wherein the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, wherein the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic; or
in respect of calculating a similarity between a packet length of the unknown traffic or the mirror of the unknown traffic and a packet length of the sampled traffic, the similarity matching server is configured to:
divide the packet length of the unknown traffic or the mirror of the unknown traffic by the packet length of the sampled traffic to obtain a quotient, wherein the quotient is the similarity between the packet length of the unknown traffic or the mirror of the unknown traffic and the packet length of the sampled traffic, or
determine a first length interval within which the packet length of the unknown traffic or the mirror of the unknown traffic falls, and determine, according to a correspondence relationship between a length interval and a similarity value, a similarity value corresponding to the first length interval, wherein the similarity value corresponding to the first length interval is the similarity between the packet length of the unknown traffic or the mirror of the unknown traffic and the packet length of the sampled traffic.

15. A communication system, comprising:
a communication network element configured to receive unknown traffic;
a deep packet inspection identification server configured to obtain the unknown traffic received by the communication network element or obtain a mirror of the unknown traffic received by the communication network element; and identify the unknown traffic or the mirror of the unknown traffic based on a deep packet inspection technology, and if the unknown traffic or the mirror of the unknown traffic fails to be identified, send the unidentified unknown traffic or the mirror of the unidentified unknown traffic to the communication network element; and
wherein the communication network element is further configured to receive the unidentified unknown traffic or the mirror of the unidentified unknown traffic from the deep packet inspection identification server, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, wherein, N is an integer greater than or equal to 2, and the N dimensions comprise two or more of the following dimensions: n1 dimensions related to a packet of the traffic, n2 dimensions related to a session corresponding to the traffic, and n3 dimensions related to the traffic itself, wherein n2, n2, and n3 are positive integers.

16. The communication system according to claim 15, wherein in respect of separately calculating similarities between the unknown traffic or the mirror of the unknown traffic and sampled traffic according to N dimensions, the communication network element is configured to perform at least two of the following similarity calculation operations:
calculating a similarity between a packet length of the unknown traffic or the mirror of the unknown traffic and a packet length of the sampled traffic;
calculating a similarity between packet payload content of the unknown traffic or the mirror of the unknown traffic and packet payload content of the sampled traffic;
calculating a similarity between a packet port number of the unknown traffic or the mirror of the unknown traffic and a packet port number of the sampled traffic;
calculating a similarity between a packet transmission rate of the unknown traffic or the mirror of the unknown traffic and a packet transmission rate of the sampled traffic;
calculating a similarity between an uplink packet quantity of the unknown traffic or the mirror of the unknown traffic and an uplink packet quantity of the sampled traffic;
calculating a similarity between a downlink packet quantity of the unknown traffic or the mirror of the unknown traffic and a downlink packet quantity of the sampled traffic;
calculating a similarity between a ratio of the uplink packet quantity to the downlink packet quantity of the unknown traffic or the mirror of the unknown traffic and a ratio of the uplink packet quantity to the downlink packet quantity of the sampled traffic;
calculating a similarity between an uplink traffic volume of the unknown traffic or the mirror of the unknown traffic and an uplink traffic volume of the sampled traffic;
calculating a similarity between a downlink traffic volume of the unknown traffic or the mirror of the unknown traffic and a downlink traffic volume of the sampled traffic;
calculating a similarity between a ratio of the uplink traffic volume to the downlink traffic volume of the unknown traffic or the mirror of the unknown traffic and a ratio of the uplink traffic volume to the downlink traffic volume of the sampled traffic; and
calculating a similarity between a traffic volume of first M packets of the unknown traffic or the mirror of the unknown traffic and a traffic volume of first M packets of the sampled traffic.

17. The communication system according to claim 16, wherein:
in respect of calculating a similarity between packet payload content of the unknown traffic or the mirror of the unknown traffic and packet payload content of the sampled traffic, the communication network element is configured to:
calculate a similarity between characters of the packet payload content of the unknown traffic or the mirror of the unknown traffic and characters of the packet payload content of the sampled traffic,
calculate a matching degree between the packet payload content of the unknown traffic or the mirror of the unknown traffic and the packet payload content of the sampled traffic, and
calculate a product of a square root of the matching degree and the character similarity, wherein the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, wherein the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic; or
in respect of calculating a similarity between a packet length of the unknown traffic or the mirror of the unknown traffic and a packet length of the sampled traffic, the communication network element is configured to:
divide the packet length of the unknown traffic or the mirror of the unknown traffic by the packet length of the sampled traffic to obtain a quotient, wherein the quotient is the similarity between the packet length of the unknown traffic or the mirror of the unknown traffic and the packet length of the sampled traffic; or
determine a first length interval within which the packet length of the unknown traffic or the mirror of the unknown traffic falls, and determine, according to a correspondence relationship between a length interval and a similarity value, a similarity value corresponding to the first length interval, wherein the similarity value corresponding to the first length interval is the similarity between the packet length of the unknown traffic or the mirror of the unknown traffic and the packet length of the sampled traffic.

18. A communication system, comprising:
a communication network element, a deep packet inspection identification server, and a similarity matching server;
wherein the communication network element is configured to receive unknown traffic;
wherein the deep packet inspection identification server is configured to obtain the unknown traffic received by the communication network element or obtain a mirror of the unknown traffic received by the communication network element; and identify, based on a deep packet inspection technology, the unknown traffic or the mirror of the unknown traffic received by the communication network element, and if the unknown traffic or the mirror of the unknown traffic fails to be identified, send the unidentified unknown traffic or the mirror of the unidentified unknown traffic to the similarity matching server; and
wherein the similarity matching server is configured to receive the unidentified unknown traffic or the mirror of the unidentified unknown traffic from the deep packet inspection identification server, and separately calculate similarities between the unknown traffic or the mirror of the unknown traffic and sampled traffic according to N dimensions; and perform weighted harmonic averaging for calculated similarities that are corresponding to the dimensions, to obtain a matching similarity between the unknown traffic or the mirror of the unknown traffic and the sampled traffic, wherein, the N dimensions comprise two or more of the following dimensions: n1 dimensions related to a packet of the traffic, n2 dimensions related to a session corresponding to the traffic, and n3 dimensions related to the traffic itself, wherein N is an integer greater than or equal to 2, and n1, n2, and n3 are positive integers.

19. The communication system according to claim 18, wherein in respect of separately calculating similarities between the unknown traffic or the mirror of the unknown traffic and sampled traffic according to N dimensions, the similarity matching server is configured to perform at least two of the following similarity calculation operations:
calculating a similarity between a packet length of the unknown traffic or the mirror of the unknown traffic and a packet length of the sampled traffic;
calculating a similarity between packet payload content of the unknown traffic or the mirror of the unknown traffic and packet payload content of the sampled traffic;
calculating a similarity between a packet port number of the unknown traffic or the mirror of the unknown traffic and a packet port number of the sampled traffic;
calculating a similarity between a packet transmission rate of the unknown traffic or the mirror of the unknown traffic and a packet transmission rate of the sampled traffic;
calculating a similarity between an uplink packet quantity of the unknown traffic or the mirror of the unknown traffic and an uplink packet quantity of the sampled traffic;
calculating a similarity between a downlink packet quantity of the unknown traffic or the mirror of the unknown traffic and a downlink packet quantity of the sampled traffic;
calculating a similarity between a ratio of the uplink packet quantity to the downlink packet quantity of the unknown traffic or the mirror of the unknown traffic and a ratio of the uplink packet quantity to the downlink packet quantity of the sampled traffic;
calculating a similarity between an uplink traffic volume of the unknown traffic or the mirror of the unknown traffic and an uplink traffic volume of the sampled traffic;
calculating a similarity between a downlink traffic volume of the unknown traffic or the mirror of the unknown traffic and a downlink traffic volume of the sampled traffic;
calculating a similarity between a ratio of the uplink traffic volume to the downlink traffic volume of the unknown traffic or the mirror of the unknown traffic and a ratio of the uplink traffic volume to the downlink traffic volume of the sampled traffic; and
calculating a similarity between a traffic volume of first M packets of the unknown traffic or the mirror of the unknown traffic and a traffic volume of first M packets of the sampled traffic.

20. The communication system according to claim 19, wherein:
in respect of calculating a similarity between packet payload content of the unknown traffic or the mirror of the unknown traffic and packet payload content of the sampled traffic, the similarity matching server is configured to:
calculate a similarity between characters of the packet payload content of the unknown traffic or the mirror of the unknown traffic and characters of the packet payload content of the sampled traffic,
calculate a matching degree between the packet payload content of the unknown traffic or the mirror of the unknown traffic and the packet payload content of the sampled traffic, and
calculate a product of a square root of the matching degree and the character similarity, wherein the product obtained by calculation is the similarity between the packet payload content of the unknown traffic or the mirror of the unknown traffic and the packet payload content of the sampled traffic, and the character similarity is equal to a quantity of same characters between the packet payload content of the unknown traffic or the mirror of the unknown traffic and the packet payload content of the sampled traffic, divided by a total quantity of characters of the packet payload content of the sampled traffic, and the matching degree is equal to 1 minus a differentiation degree between the packet payload content of the unknown traffic or the mirror of the unknown traffic and the packet payload content of the sampled traffic, wherein the differentiation degree is equal to a quantity of characters, in the packet payload content of the sampled traffic, which are different from characters in the packet payload content of the unknown traffic or the mirror of the unknown traffic, divided by a total quantity of characters of the packet payload content of the sampled traffic; or
in respect of calculating a similarity between a packet length of the unknown traffic or the mirror of the unknown traffic and a packet length of the sampled traffic, the similarity matching server is configured to:
divide the packet length of the unknown traffic or the mirror of the unknown traffic by the packet length of the sampled traffic to obtain a quotient, wherein the quotient is the similarity between the packet length of the unknown traffic or the mirror of the unknown traffic and the packet length of the sampled traffic, or
determine a first length interval within which the packet length of the unknown traffic or the mirror of the unknown traffic falls, and determine, according to a correspondence relationship between a length interval and a similarity value, a similarity value corresponding to the first length interval, wherein the similarity value corresponding to the first length interval is the similarity between the packet length of the unknown traffic or the mirror of the unknown traffic and the packet length of the sampled traffic.

21. A traffic analysis server, comprising:
a receiver configured to receive unknown traffic or a mirror of unknown traffic;
a similarity identification engine coupled with the receiver;
a transmitter configured to:
send a matching similarity between the unknown traffic and sampled traffic, or
send a matching similarity between the mirror of the unknown traffic and sampled traffic, or
send a matching similarity between the unknown traffic output by the similarity identification engine and sampled traffic, or
send a matching similarity between the mirror of the unknown traffic output by the similarity identification engine and sampled traffic; and
wherein the similarity identification engine is configured to:
obtain unknown traffic, and
separately calculate, according to N dimensions, similarities between sampled traffic and the unknown traffic obtained by the obtaining unit; and perform weighted harmonic averaging for calculated similarities that are corresponding to the dimensions, to obtain a matching similarity between the unknown traffic and the sampled traffic, wherein, N is an integer greater than or equal to 2, and the N dimensions comprise two or more of the following dimensions: n1 dimensions related to a packet of the traffic, n2 dimensions related to a session corresponding to the traffic, and n3 dimensions related to the traffic itself, wherein n1, n2, and n3 are positive integers.
